(19) United States
(12) Patent Application Publication
(10) Pub. No.: US 2014/0357336 A1
(43) Pub. Date: Dec. 4, 2014

(54) ELECTRONIC VIDEO POKER SYSTEM AND METHOD OF USE

(71) Applicants: Robert D. Williams, Cebu (PH); Anthony Chaskelson, Las Vegas, NV (US); Leonard Barshack, Ketchum, ID (US)

(72) Inventors: Robert D. Williams, Cebu (PH); Anthony Chaskelson, Las Vegas, NV (US); Leonard Barshack, Ketchum, ID (US)

(21) Appl. No.: 14/089,268

(22) Filed: Nov. 25, 2013

Related U.S. Application Data
(60) Provisional application No. 61/830,126, filed on Jun. 2, 2013.

(51) Int. Cl. G07F 17/32

(52) U.S. Cl. CPC G07F 17/3293
USPC 463/13

(57) ABSTRACT

A video poker system configured to play a video game involving multiple hands (also termed paylines). Two hole cards are used in combination with a series of five-card hands to form a series of seven-card hands comprising five horizontal hands and two diagonal hands. After one of said two hole cards is revealed players are able to increase a game wager after which the second hole and series of five-card hands are revealed. Players are able to replace one or more of the series of five-card hands in an effort to obtain a stronger outcome. In one version, a specialized deck of fifty seven playing cards is used in lieu of a conventional deck of fifty two playing cards. The five extra cards comprise five face cards of a different suit (e.g., Eagle suit). The use of fifty seven cards creates additional hands and allows larger payouts.

### CROSS-REFERENCES

This application claims the benefit of U.S. Provisional Patent Application No. 61/830,126 filed Jun. 2, 2013 which is incorporated herein for any and all purposes.

### FIELD OF THE INVENTION

The embodiments of the present invention relate to an electronic video poker for playing video poker games of chance.

### BACKGROUND

Video poker is a popular game of chance played in casinos throughout the world. In general, after placement of a wager, five cards are displayed face-up from a conventional deck of fifty two playing cards. Players are then able to hold or discard each of the cards where discards are replaced by new cards from the conventional deck of cards. Players are paid based on the strength of the resulting five-card hand. Video poker is popular in part because of the ease and quickness of play. Despite its popularity, conventional video poker can become boring or tedious over time. In addition, video poker is based on draw poker which is a poker game not played with any true significance in today's poker circles. Today's poker is ruled by Texas Hold'em.

Thus, it would be advantageous to develop a video poker system for facilitating a video poker game which is based on Texas Hold'em and provides more excitement, additional betting and payout opportunities, a variety of pay tables and other enhancements.

### SUMMARY

The embodiments of the present invention are directed to a video poker system facilitating a video poker game involving multiple hands (also termed paylines) allowing additional betting opportunities and pay tables to be utilized. In one embodiment, two hole cards are used in combination with a series of five-card hands to form a series of seven-card hands. In one embodiment, the two hole cards are used in combination with five, five-card hands forming a 5×5 matrix to create up to seven, seven-card hands comprising five horizontal hands and two diagonal hands. In one embodiment, one of said two hole cards is revealed after which players are able to increase a game wager prior to the second hole card and series of five-card hands being revealed. In other embodiments the initial wager may be increased, decreased or surrendered during various stages of the game.

In one embodiment, players are able to replace one or more of the series of five-card hands in an effort to obtain a stronger outcome. In one embodiment, a specialized deck of fifty seven playing cards is used in lieu of a conventional deck of fifty two playing cards. The five extra cards comprise five face cards of a different suit (e.g., Eagle suit) relative to the conventional suits of Hearts, Spades, Diamonds and Clubs. The use of fifty seven cards creates additional hands and allows larger payouts.

Various pay tables described herein relate to the horizontal hands, diagonal hands and a combination thereof. It is also conceivable that pay tables may be generated for vertical hands as well.

Other variations, embodiments and features of the present invention will become evident from the following detailed description, drawings and claims.

### BRIEF DESCRIPTION OF THE DRAWINGS

FIG. 1 illustrates a block diagram of components of an electronic gaming device for conducting a video poker game according to the embodiments of the present invention;

FIG. 2 illustrates a block diagram of a wireless system accessible by a mobile device for conducting a video poker game according to the embodiments of the present invention;

FIGS. 3a-3i illustrate a series of screen shots detailing a first method of playing a video poker game according to the embodiments of the present invention;

FIG. 4 illustrates a screen shot detailing a final outcome using a fifty seven card deck according to the embodiments of the present invention;

FIG. 5 illustrates a flow chart detailing one methodology for conducting a video poker game according to the embodiments of the present invention;

FIGS. 6a-6f illustrate a series of screen shots corresponding to the flow chart of FIG. 5 according to the embodiments of the present invention;

FIG. 7 illustrates a flow chart detailing another methodology for conducting a video poker game according to the embodiments of the present invention; and

FIG. 8 illustrates a screen shot depicting an exemplary graphic user interface of a game played according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the embodiments of the present invention involve both hardware and software elements which portions are described below in such detail required to construct and operate a game method and system according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a stand-alone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks. As used herein, a “terminal” should be understood to be any one of a general purpose computer, as for example a personal computer or a laptop computer, a client computer configured for interaction with a server, a special purpose computer such as a server, or a smart phone, soft phone, tablet computer, personal digital assistant or any other machine adapted for executing programmable instructions in accordance with the description thereof set forth above.

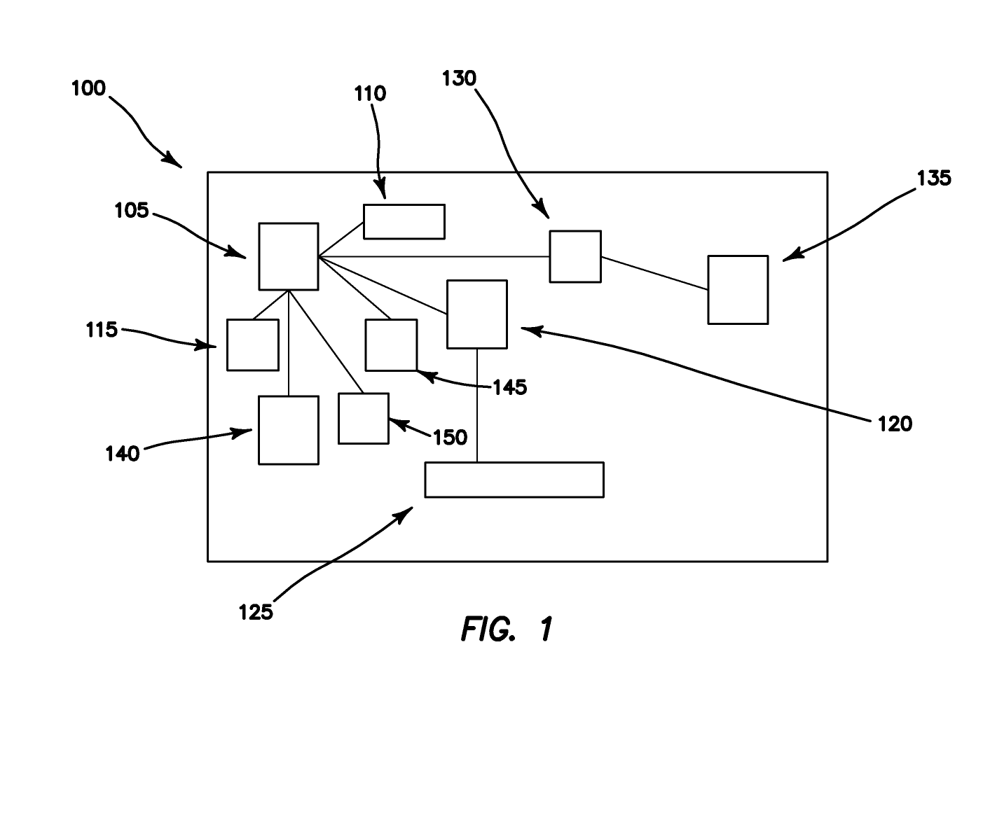

The embodiments of the present invention may be facilitated by an electronic gaming device whereby a single player plays against the electronic gaming device's processor as described herein. The electronic gaming device may be a standalone device or bar-top device. A block diagram of the electronic gaming device 100 is shown in FIG. 1. The exemplary electronic gaming device 100 may include a central processing unit (CPU) also deemed a processor 105 which controls the electronic gaming device 100 based on instructions stored in program read-only memory (ROM) 110 and pay table ROM 115. Program ROM 110 stores executable instructions related to the operation of the gaming device 100 and which are generally permanent. CPU 105 may be connected to a video controller 120 which provides output to one or more video displays 125. Similarly, an audio controller 130 provides audio output as dictated by the CPU 105 through speakers 135. The aforementioned components, and others, may be attached to a circuit board forming a motherboard. In another embodiment, the electronic gaming device 100 may be linked to a central game server which allows players to select from a number of games via the electronic gaming device 100. In such an embodiment, one or more processors integrated into the central server control the gaming device 100 based on instructions stored in program ROM 110.

A user interface 140 may respond to buttons on button panel or display incorporating touch screen technology or any other devices providing means for users to communicate with, and instruct, the electronic gaming device 100. Wager memory 145 stores an amount of money/credits deposited into the electronic gaming device 100 by a player and specific wager information related to each play of the electronic gaming device 100. Payout system 150 includes a coupon printer or similar device for receiving money/coupon from the electronic gaming device 100.

Those skilled in the art will recognize that the configuration and features of the electronic gaming device 100 disclosed herein are exemplary and may be altered in any number of ways without impacting the embodiments of the present invention.

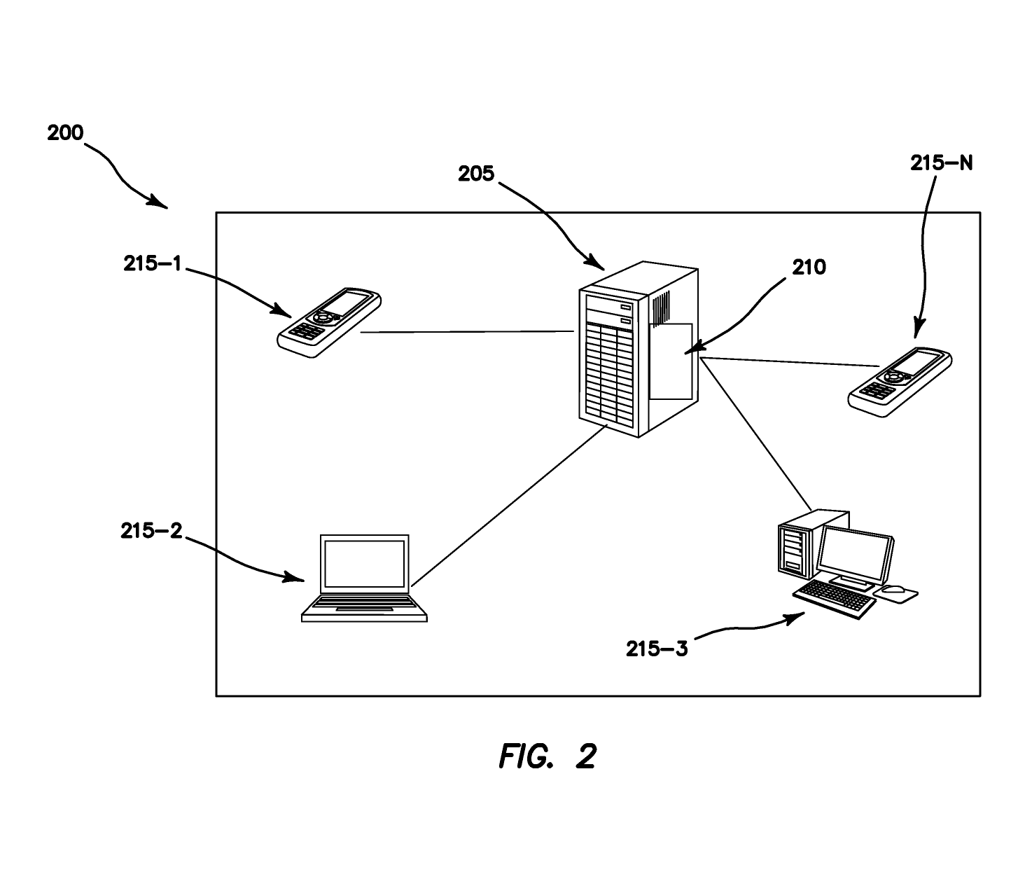

FIG. 2 shows a block diagram of a wireless system 200 which may be used to facilitate remote play of the game according to the embodiments of the present invention. The wireless system 200 comprises a game server 205, including one or more processors 210 running game software, and remote devices 215-1 through 215-N (e.g., smart phones) configured to access said game server 205 facilitating game play on the remote devices 215-1 through 215-N. In another embodiment, the video game according to the embodiments of the present invention may be in the form of a software application (“App”) downloadable onto smart phones, tablets or computers and playable via processing power and a user interface associated therewith.

The embodiments of the present invention are directed to a video poker game involving multiple hands (also termed paylines). The description herein focuses on a Texas Hold'em embodiment using two common cards in combination with five, five-card hands. Those skilled in the art will recognize that more or less than two common cards and five, five-card hands may be used. Similarly, the five, five-card hands may be replaced with hands having more or less than five cards.

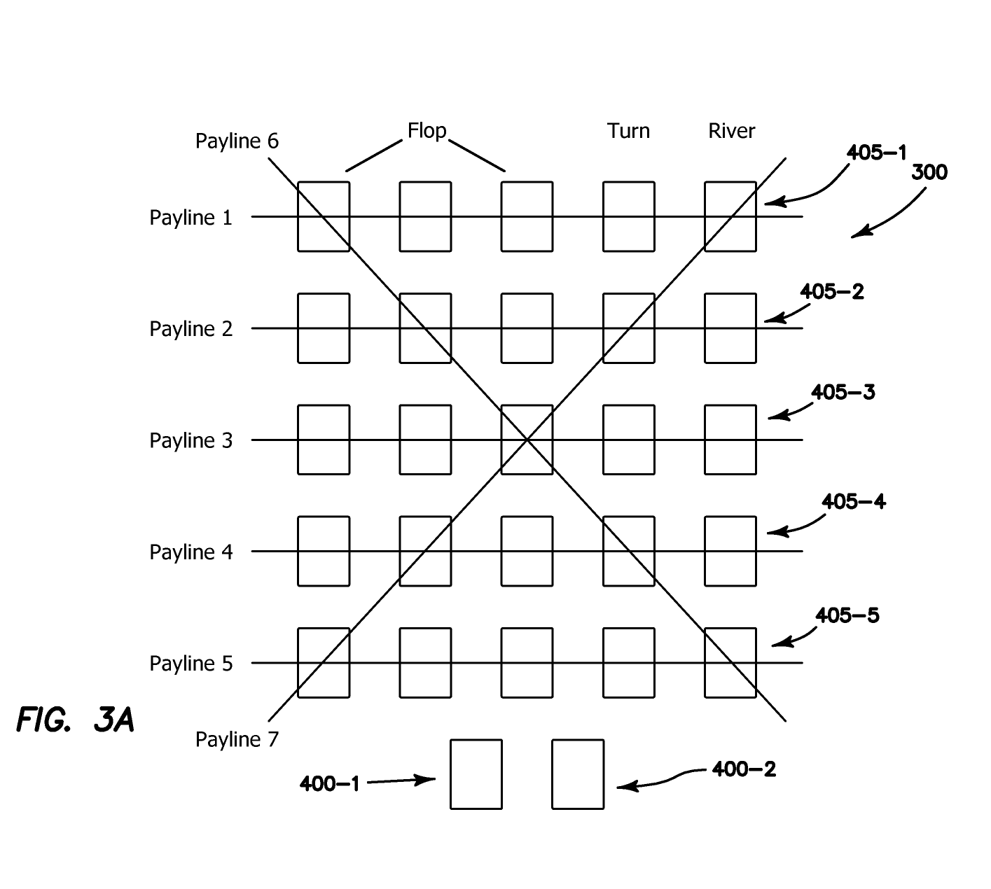

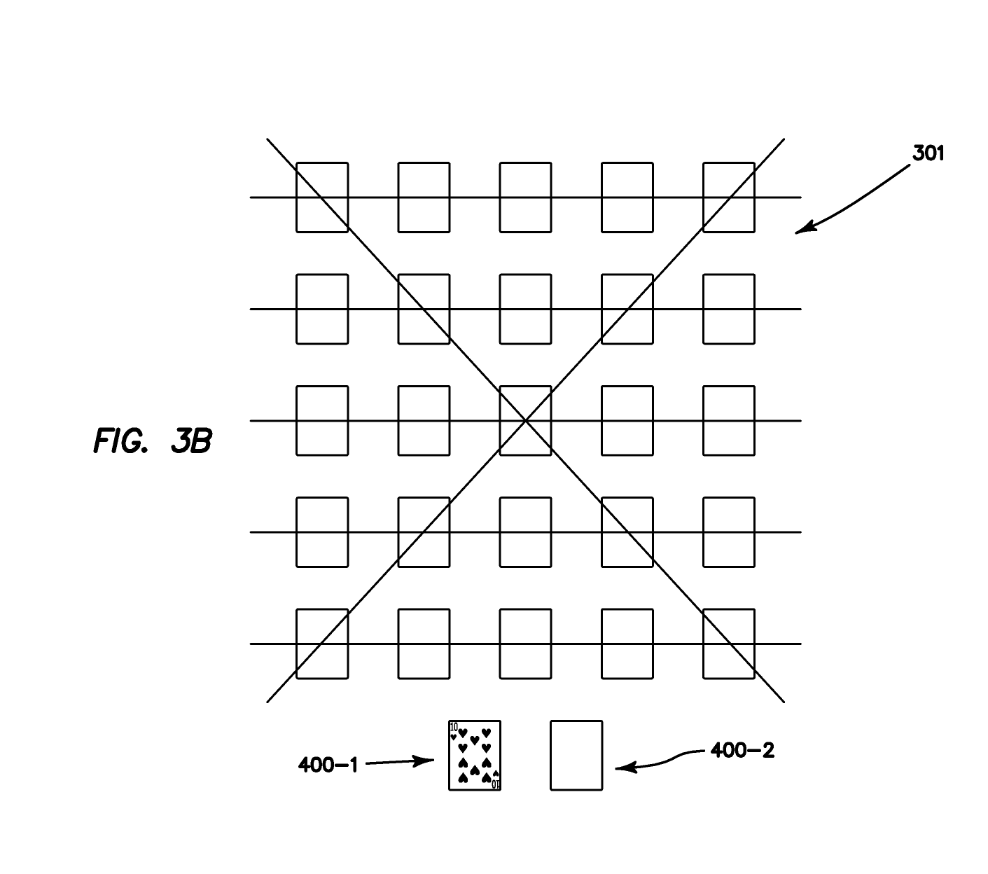

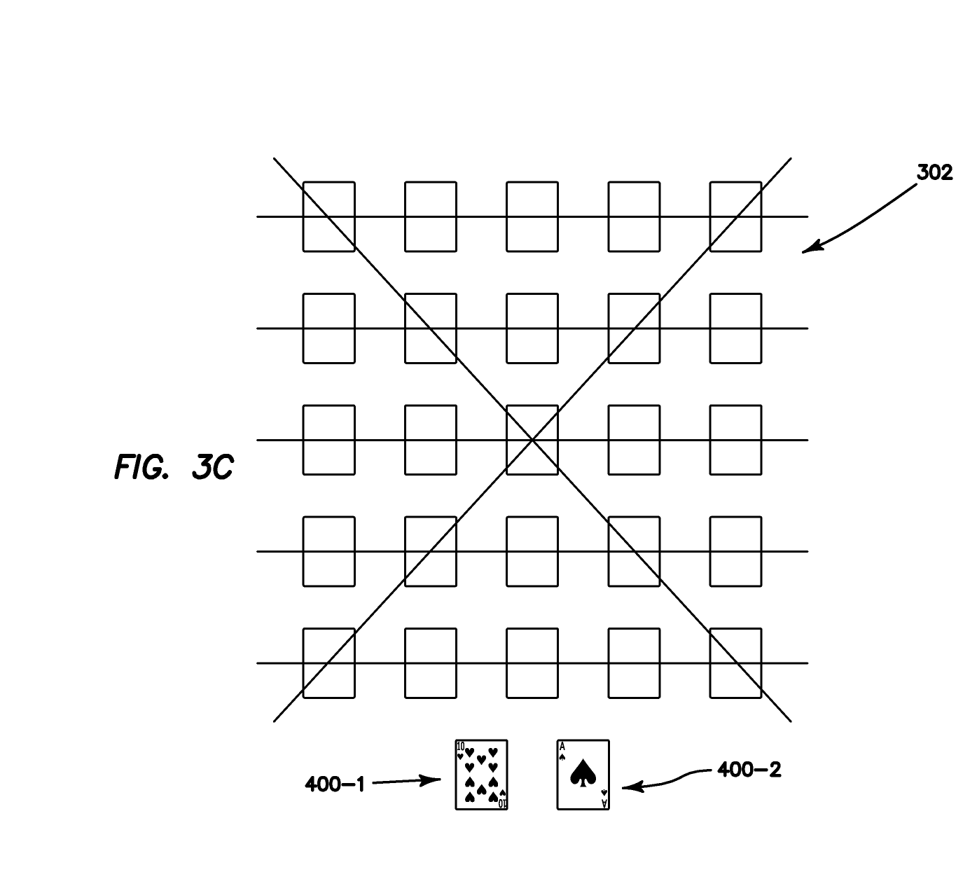

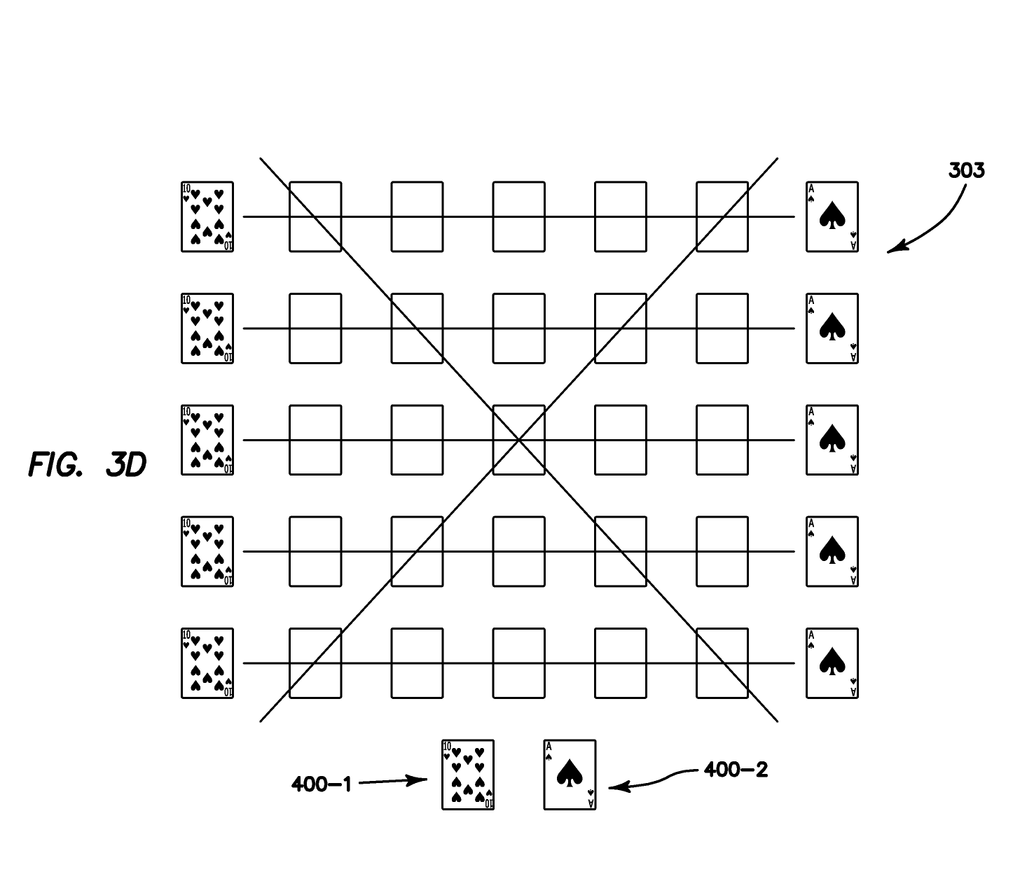

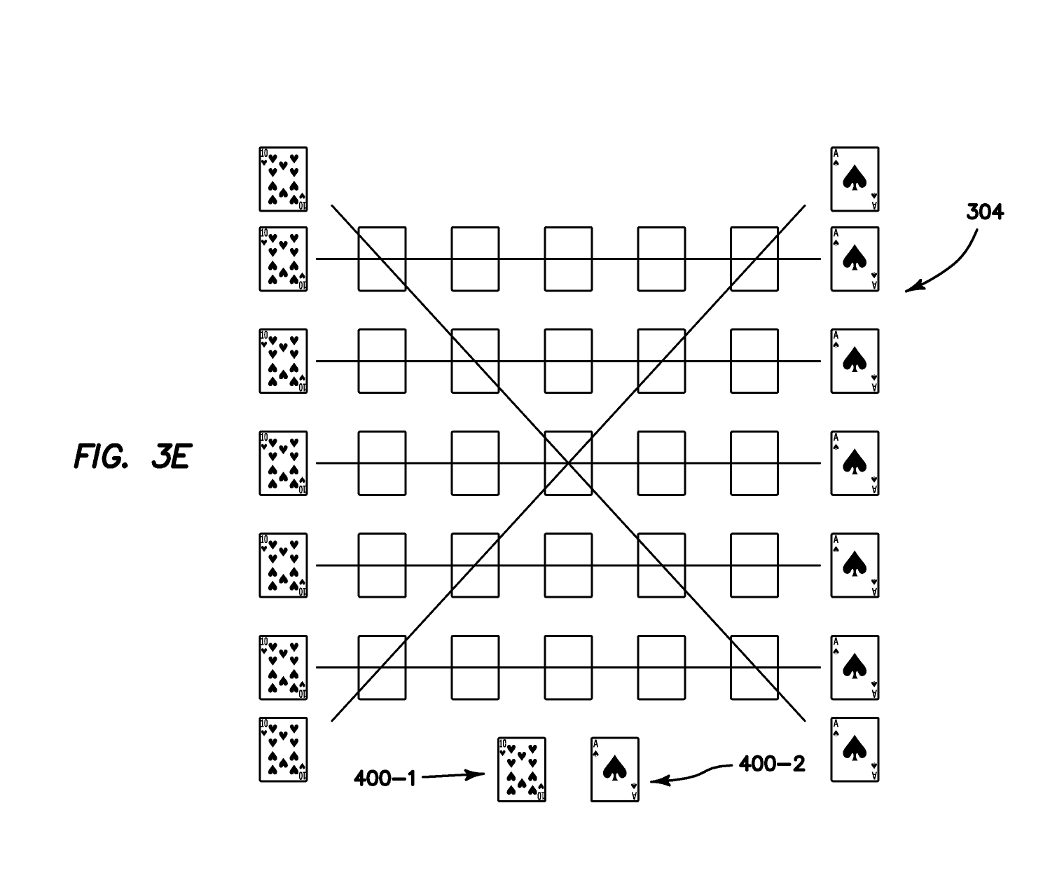

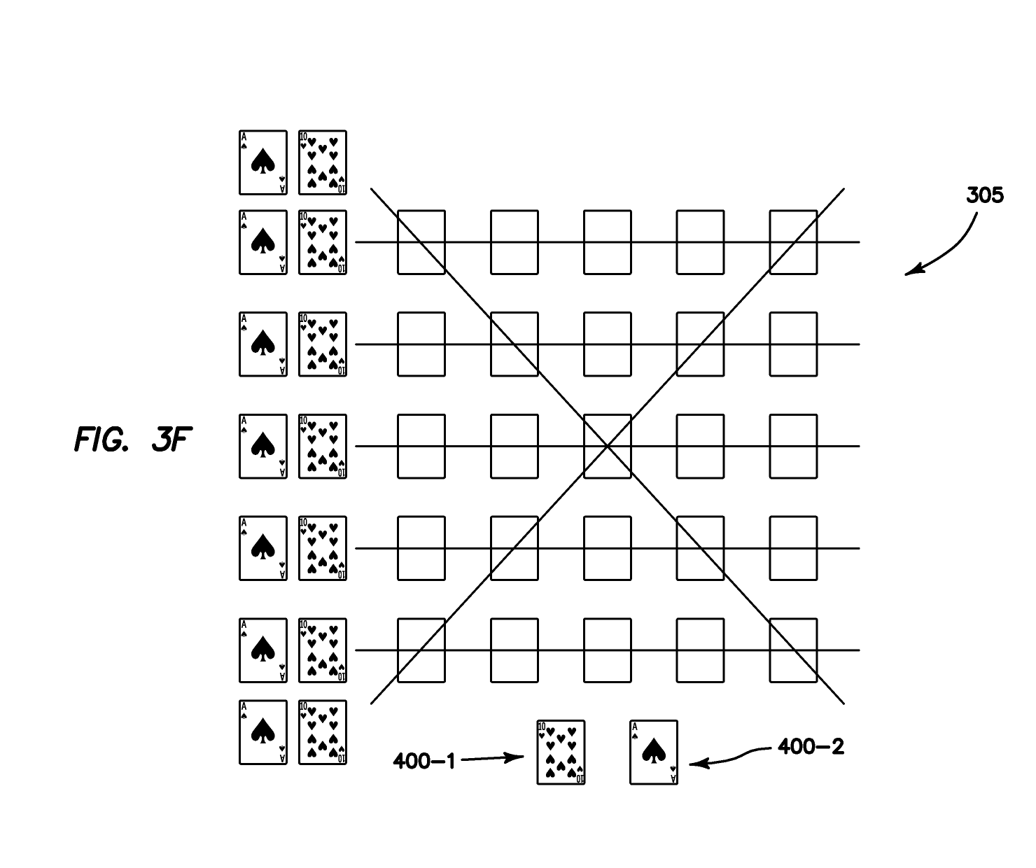

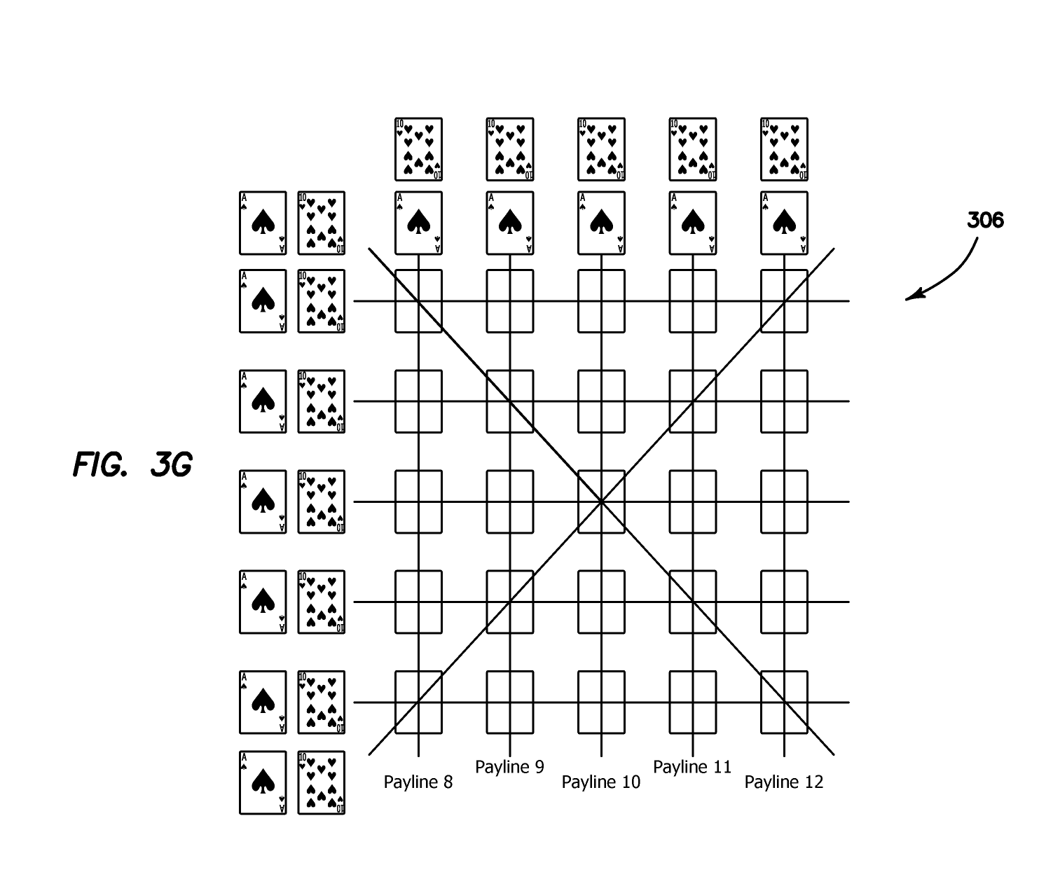

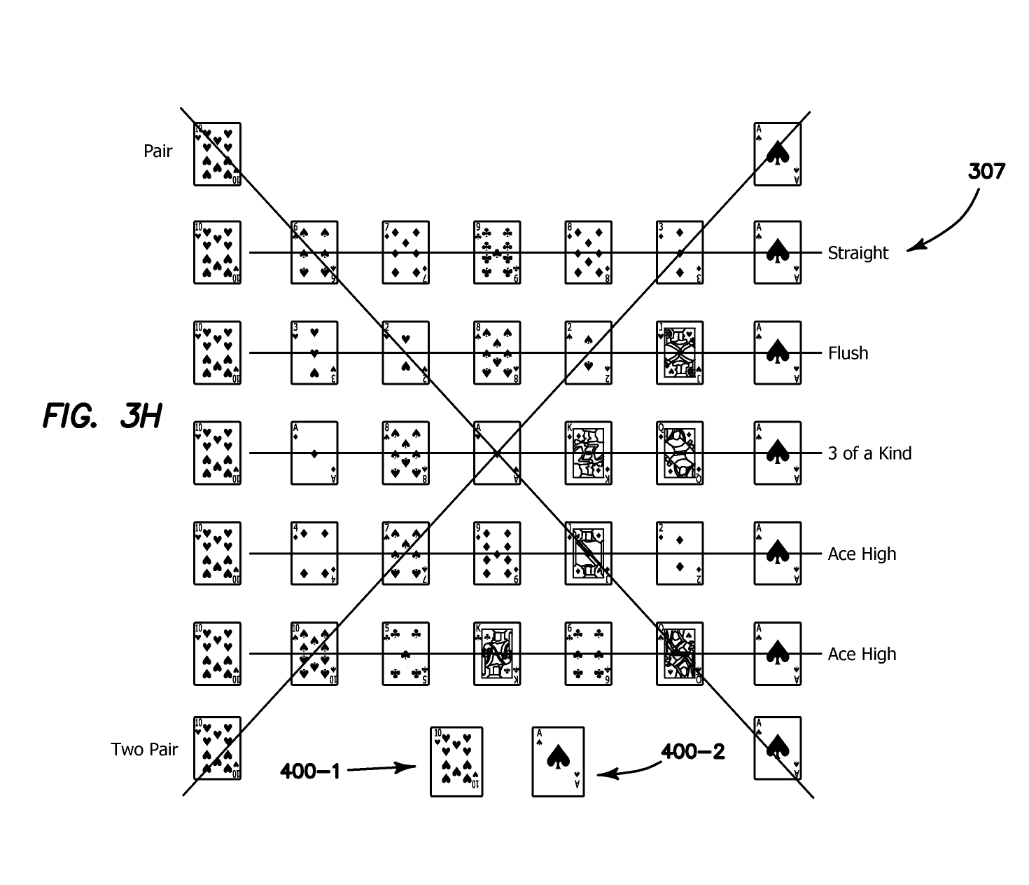

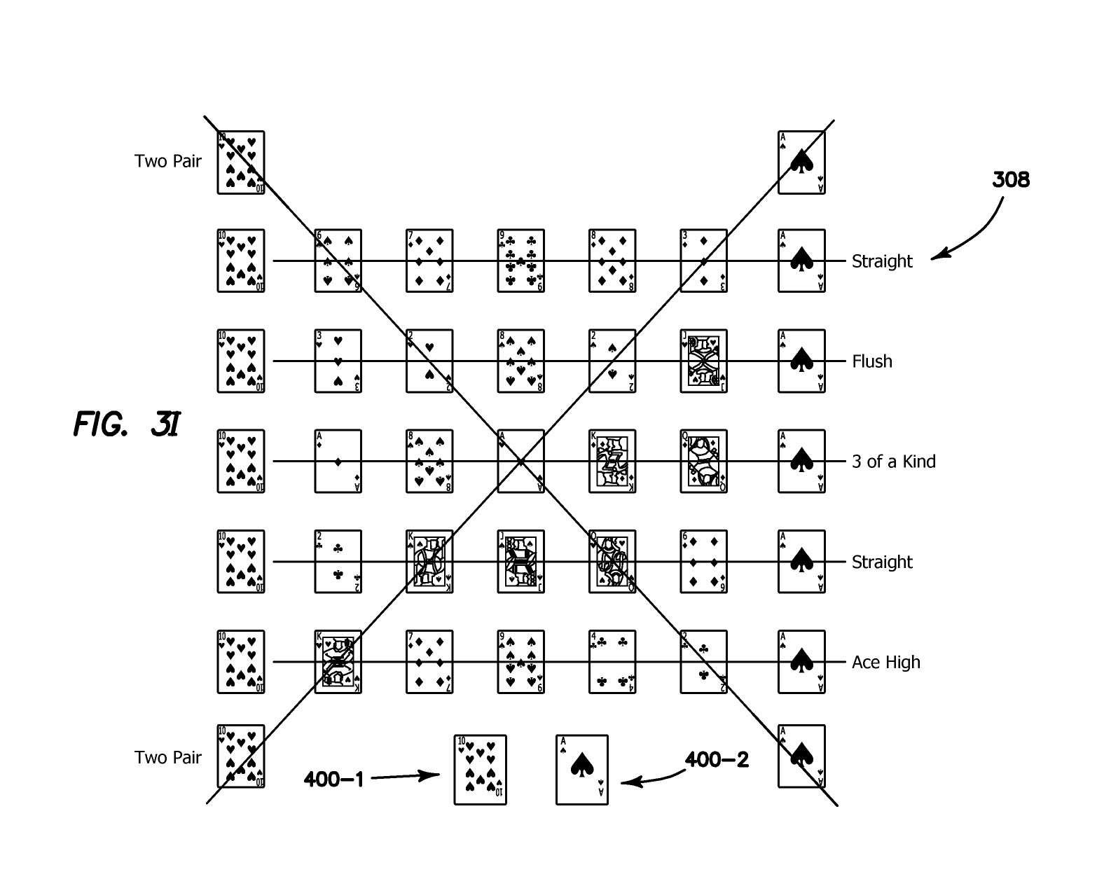

FIGS. 3a-3i show a series of screen shots facilitated by an electronic gaming device detailing a first method of playing a video poker game according to the embodiments of the present invention. FIG. 3a shows an initial screen shot 300 depicting two common cards 400-1, 400-2 and five, five-card hands 405-1 through 405-5. The first three cards of each of the five-card hands 405-1 through 405-5 may be designated as flop cards while the fourth card may be designated the turn card and the fifth card may be designated the river card synonymous with Texas Hold'em designations. The five, five-card hands 405-1 through 405-5 may be identified by paylines 1-5 in a slot machine like manner. In some embodiments, the two diagonals may be identified by paylines 6 and 7.

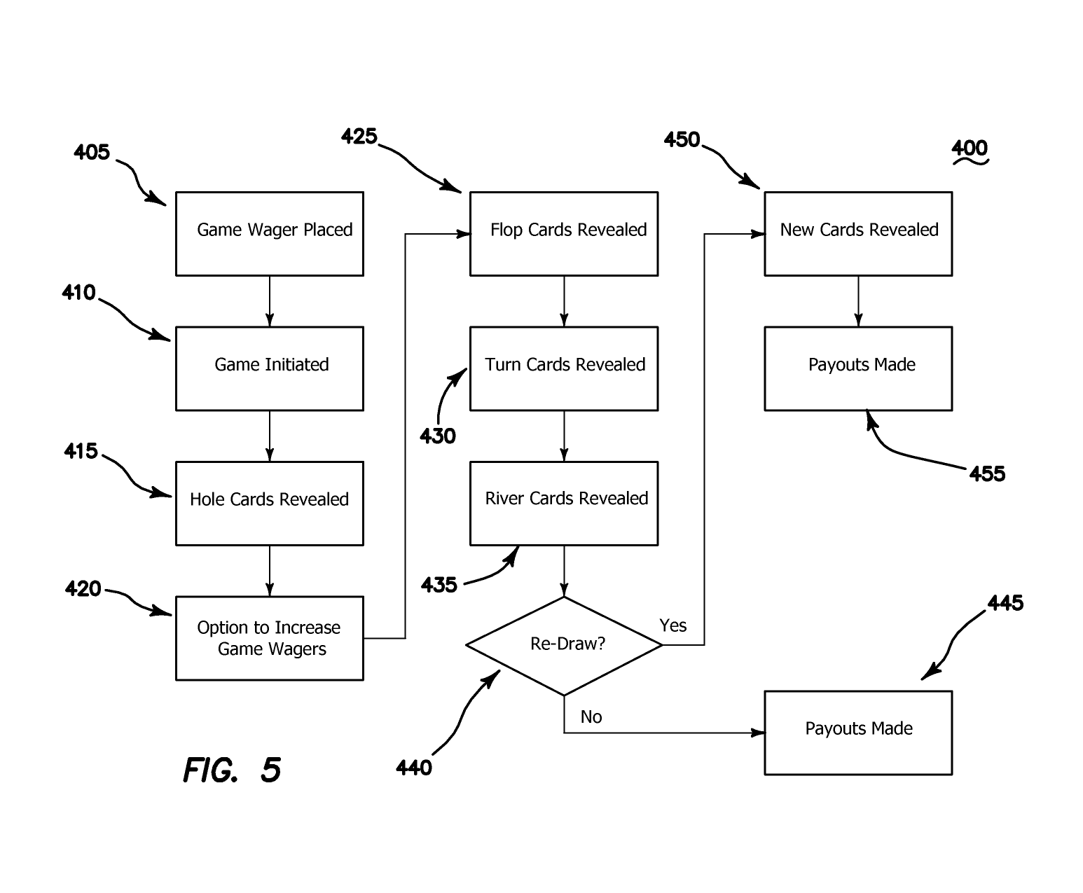

FIG. 3b shows screen shot 301 after one of the common cards 400-1 (10 of Hearts) has been revealed. At this stage, in one embodiment, the player may increase an amount of a wager placed to begin the game as detailed in the flow chart of FIG. 5. FIG. 3c shows screen shot 302 after the second one of the common cards 400-2 (Ace of Spades) has been revealed. In one embodiment, the common cards 400-1, 400-2 may be revealed in a spinning fashion akin to a video slot machine and/or simultaneously. In FIGS. 3d-3g, screen shots 303-306 show exemplary options for displaying the common cards 400-1, 400-2 to facilitate easy recognition of poker hands. In FIG. 3d, screen shot 303 shows the common cards 400-1, 400-2 replicated on opposite sides of each payline 1-5 defining five, seven-card hands. In FIG. 3e, screen shot 304 shows the common cards 400-1, 400-2 replicated on opposite sides of each payline 1-7 defining seven, seven-card hands. In FIG. 3f, screen shot 305 shows seven sets of the common cards 400-1, 400-2 replicated on a left side proximate each payline 1-7 defining seven, seven-card hands. In another embodiment, the seven sets of the common cards 400-1, 400-2 are replicated in a similar manner as depicted in screen shot 305 except the common cards 400-1, 400-2 are placed proximate the diagonal paylines 6, 7 and angled to align with paylines 6, 7 defining seven, seven-card hands. In FIG. 3g, screen shot 306 shows seven sets of the common cards 400-1, 400-2 replicated in a similar manner as depicted in screen shot 305 along with common cards 400-1, 400-2 replicated above each of the five cards forming twelve, five-card hands (i.e., five horizontal, two diagonal and five vertical paylines 8-12).

Replication of the common cards 400-1, 400-2 makes identifying the seven-card hands a simpler, quicker task for players. In FIG. 3h, screen shot 307 shows the cards forming hands 405-1 through 405-5 being revealed such that paylines 1-7 identify a straight, flush, three of a kind, Ace high, Ace high, pair and two pair, respectively. In this example, the player may elect to hold the cards in paylines 1 (straight), 2 (flush) and 3 (three of a kind) and redraw the cards in the other two horizontal paylines 4 and 5. In other embodiments, players may be able to redraw cards along the diagonal paylines 6, 7 as well. By way of example, FIG. 3i shows a screen shot 308 after the player redraws cards in paylines 4 and 5. As shown, payline 4 improved to a straight and payline 5 remains Ace high. Drawing along the horizontal paylines 1-5 also impacts the diagonal paylines 6, 7. In this instance, payline 6 improved to two pairs and payline 7 remains a pair. Each payline 1-7 is then evaluated and a corresponding payout is paid based on the wager and the strength of the hands defined by each payline 1-7. Alternatively, only paylines 1-5 are evaluated and receive payouts while diagonal paylines 6, 7 are only paid if a bonus wager is placed prior to the start of the game. In such an embodiment, paylines 6, 7 act as bonus paylines activated responsive to a separate wager. Other payout schemes are detailed below.

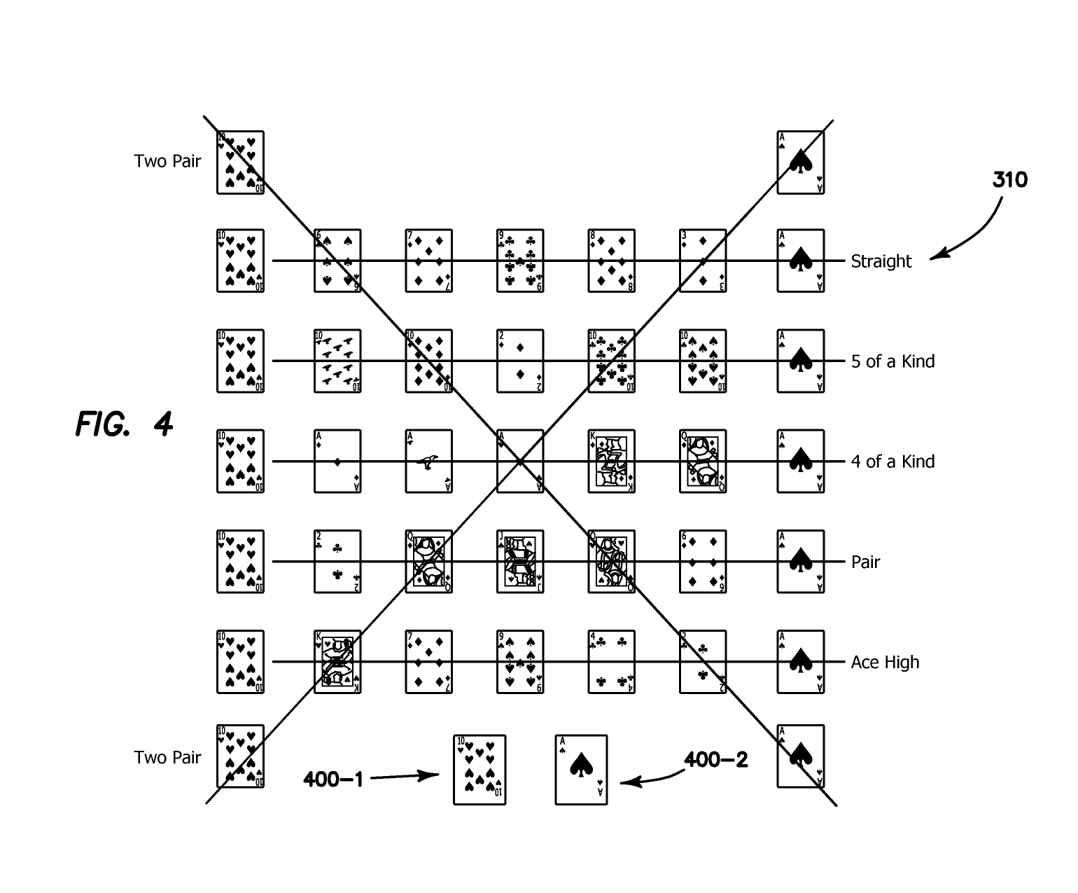

In another embodiment of the present invention, the game is played in the same manner but with a modified deck of playing cards. Rather than using a conventional deck of fifty two playing cards, a deck of fifty seven playing cards is used. The fifty seven card deck comprises the fifty two cards from the conventional fifty two card deck and five new cards of a different, new suit of cards. For example, a 10, Jack, Queen, King and Ace of Eagles may be added. Those skilled in the art will recognize that the new suit (or house suit) may take any form, symbol and/or name desired by the operator. Such a new suit may be used to develop a theme for the game (e.g., Eagles Video Poker) and to promote the property in which the game is offered or promote a business within the property. Regardless of the form, symbol and/or name adopted for the house suit, its use generates new hands, new payouts and new probabilities for establishing larger payouts which are attractive to players. For example, five of a kind hands are possible as well as another royal flush. FIG. 4 shows screen shot 310 depicting a final game outcome after the draw involving a fifty seven card deck. With the new Eagle suit, the paylines 1-7 define a straight, five of a kind, four of a kind, pair, Ace high, two pairs and two pairs, respectively.

In one embodiment, payouts are based on both a strength of resultant hands identified by the paylines and a number of paylines identifying winning hands. Tables 1 and 2 show exemplary pay tables for a game incorporating one or more wild cards and a house suit of five cards comprising a 10, Jack, Queen, King and Ace.

TABLE 1

| Number of Paylines | |
|---|---|
| Identifying a Winning Hand | |
| as Defined by Pay Table | Payout ($1 Bet) |
| 0 | $5000 |
| 7 | $5 |
| 6 | $1 |
| 5 | .25 |
| 4 | .20 |
| 3 | .15 |
| 2 | .10 |
| 1 | .05 |

TABLE 2

| Rank of Hand | Payout ($1 Bet) |
|---|---|
| Wild Royal Flush | $10000 |
| Five of a Kind | $5000 |
| Royal Flush | $3000 |
| Straight Flush | $2000 |
| Four of a Kind | $5.00 |
| Full House | .50 |
| Flush | .25 |
| Straight | .20 |
| Three of a Kind | .15 |
| Two Pair | .10 |
| House Cards | .05 |

Under the payouts set forth in Tables 1 and 2, a payout would always occur since Table 1 includes a payout for 0 lines identifying a winning hand. In other embodiments, payouts are based on the strength of the hands identified by the paylines only or other criteria as detailed below.

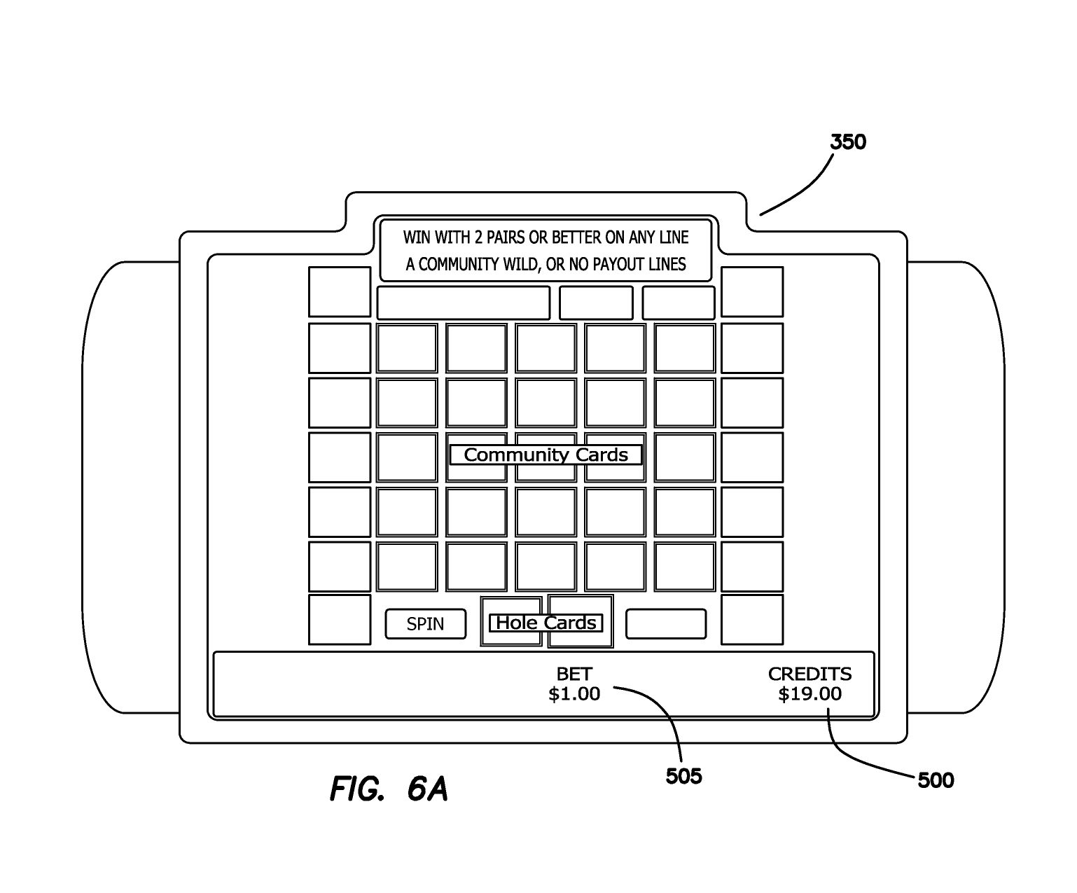

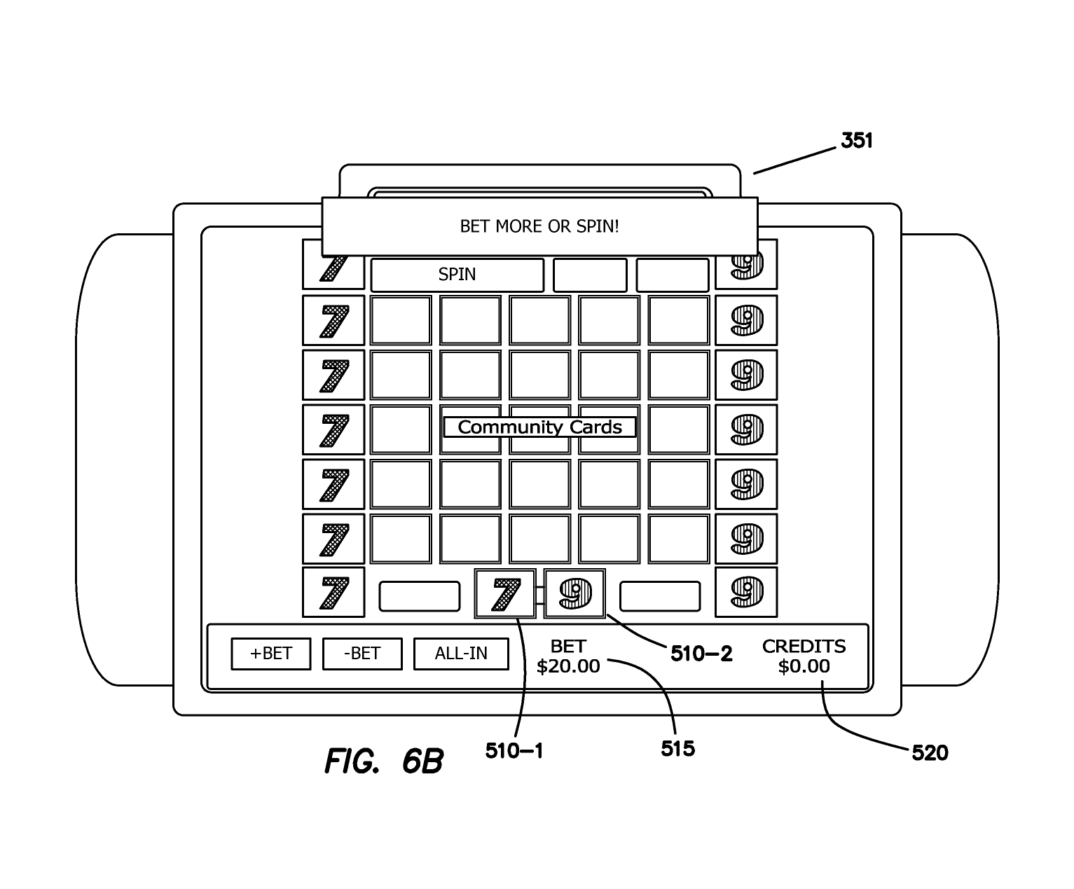

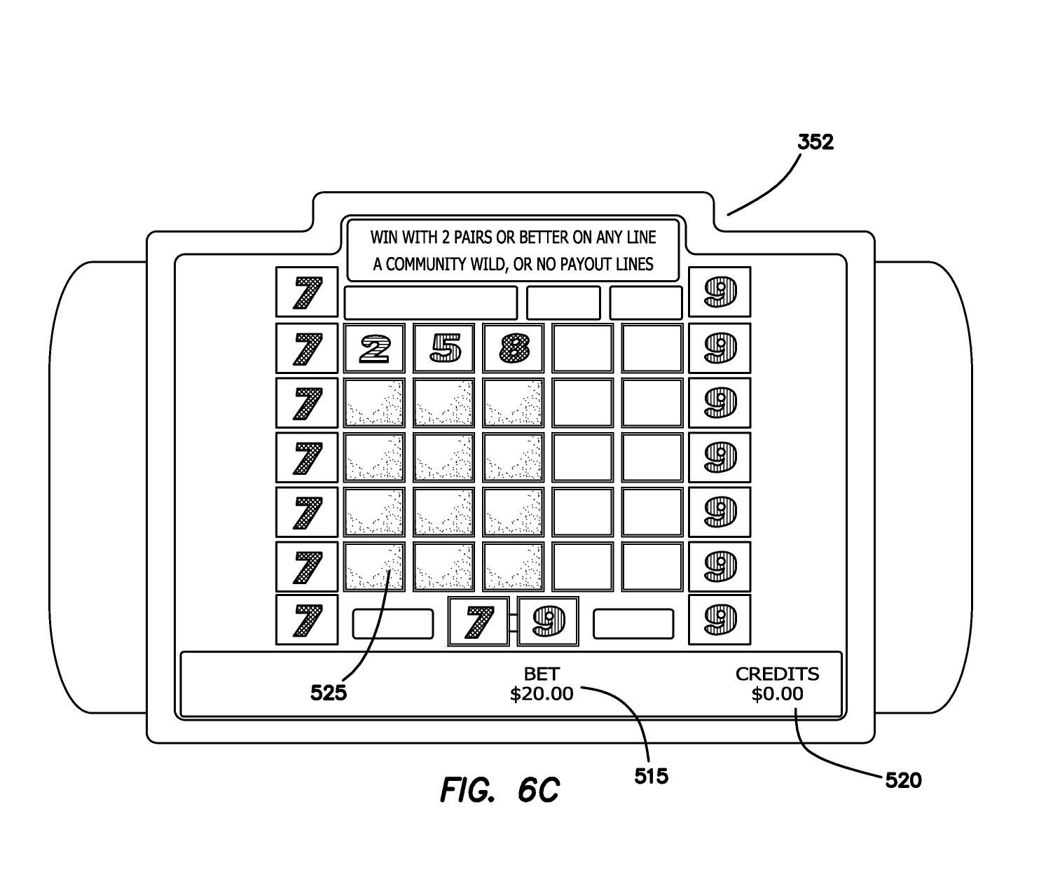

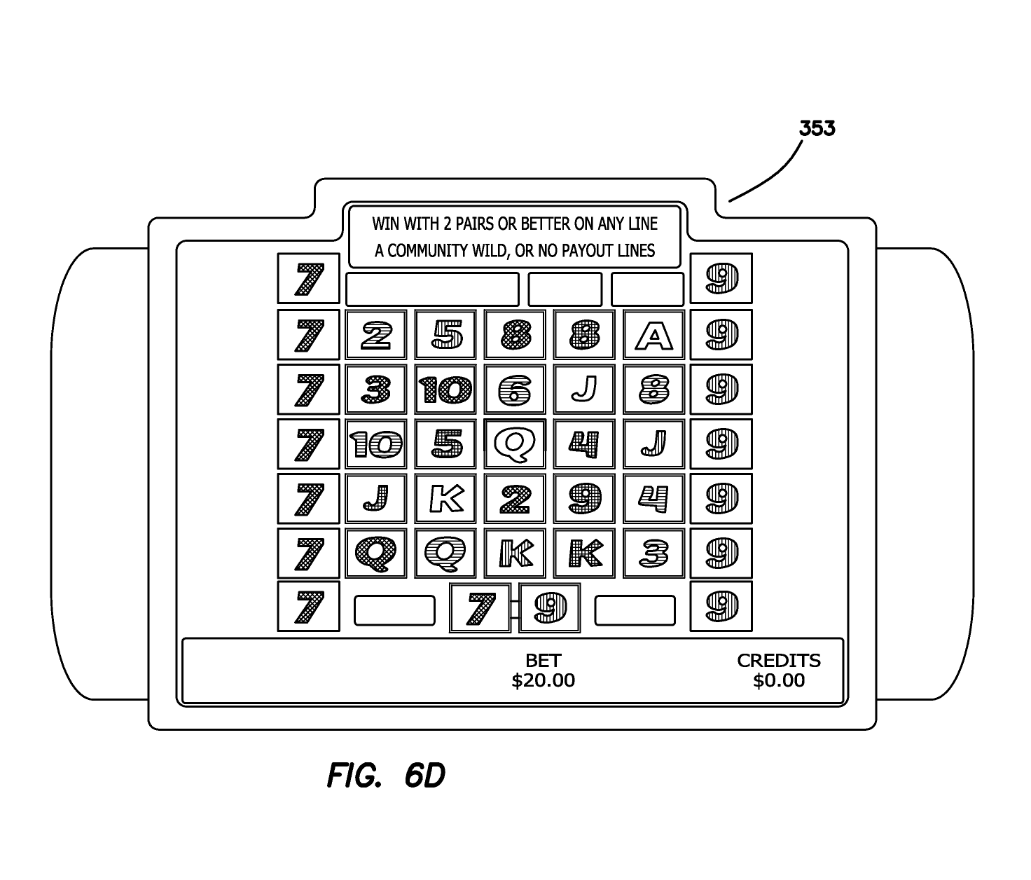

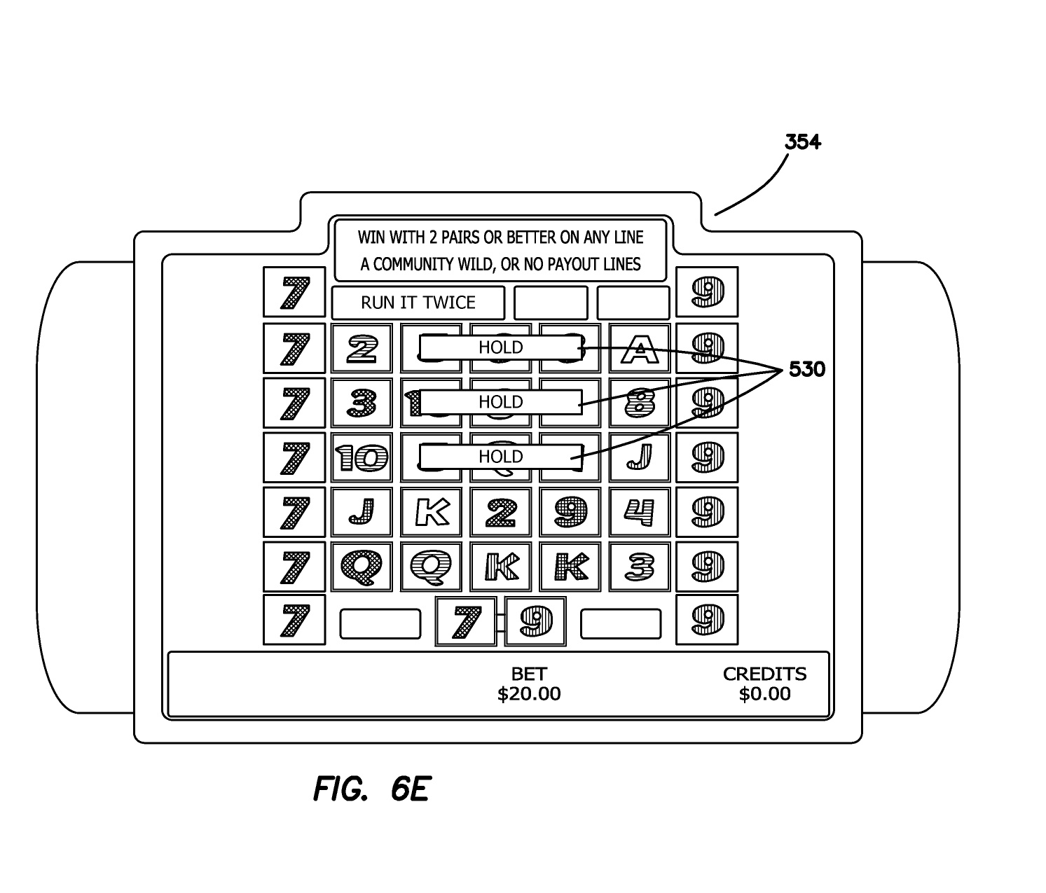

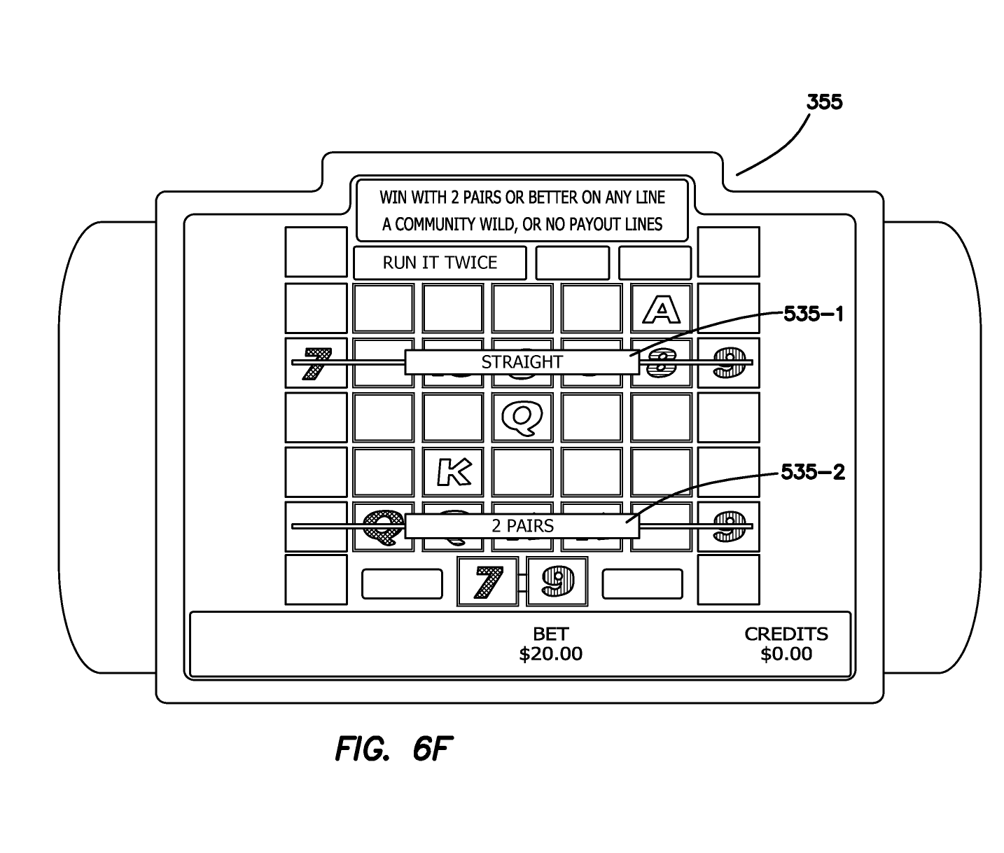

FIG. 5 shows a flow chart 400 detailing one methodology of conducting a video game according to the embodiments of the present invention. At 405, a game wager is placed as shown in screen shot 350 of FIG. 6a. Game wagers are typically deducted from a credit balance stored in the electronic gaming device (e.g., standalone video poker machine) or an account accessible by the electronic gaming device (e.g., smartphone). A single wager may cover all available paylines or individual wagers may need to be placed to play one or more of the paylines akin to multiple payline slot machines. In one embodiment, a bonus wager is required to activate potential payouts along the diagonal paylines. As shown in screen shot 350 of FIG. 6a, the credit balance 500 is $19.00 ($20-$1) and the bet amount 505 is $1.00. In other embodiments, a player may be required to place a wager for each hand or payline. Once the wager is placed, at 410, the player initiates play by utilizing a deal button, icon or other interface member. In another embodiment, game play is initiated automatically responsive to a max wager being placed. Operators establish minimum and maximum wager amounts. At 415, the hole cards 510-1, 510-2 are revealed as shown in screen shot 351 of FIG. 6b. In one embodiment, the hole cards 510-1, 510-2 are revealed in a spinning manner akin to a video slot machine. In another embodiment, the hole cards 510-1, 510-2 are simply displayed in a manner akin to a conventional video poker game. The hole cards 510-1, 510-2 may also be revealed one-at-a-time allowing initial wagers to be increased before the second hole card is revealed. As shown in screen shot 351 of FIG. 6b, the hole cards 510-1, 510-2 are replicated proximate to each of the seven paylines comprising the five horizontal paylines and two diagonal paylines. At 420, in one embodiment, the player has the option to increase the wager placed at 405. Screen shot 352 of FIG. 6b shows the player increasing the initial $1 wager to $20 515 and leaving a credit balance 520 of $0. Again, operators will dictate if, and how much, a player can increase an initial wager. In other embodiments, the player may be able to decrease or surrender the original wager once the hole cards 510-1, 510-2 are revealed. At 425, as shown in screen shot 352 of FIG. 6c, in one embodiment, the three flop cards in each of the five horizontal paylines are revealed in a spinning fashion 525 or video poker fashion. At 430, the turn card (i.e., 4^{th} card) in each of the five horizontal paylines is revealed in a spinning fashion of video poker fashion. In one embodiment, players may increase, decrease or surrender wagers again. At 435, the river card (i.e., 5^{th} card) in each of the five horizontal paylines is revealed in a spinning fashion of video poker fashion. In another embodiment, the flop cards, turn cards and river cards are all revealed simultaneously. At 440, players have the option to re-draw the cards along one or more of the five horizontal paylines. Screen shot 353 of FIG. 6d shows all cards revealed. Screen shot 354 of FIG. 6e shows a player electing to hold 530 at least paylines 1-3. Accordingly, the cards along paylines 4 and 5 may be replaced while cards in paylines 1-3 are held (i.e., no redraws along those paylines). In other embodiments, the players may re-draw cards along the diagonal paylines and/or individual cards anywhere in the 5×5 matrix. The re-draw does not include the hole cards placed proximate to the five horizontal paylines. If no re-draws are requested, at 445, payouts related to the five-card hands formed along the five horizontal paylines and/or two diagonal paylines are determined and paid. If re-draws are requested, at 450, new replacement cards are displayed along the horizontal paylines (and indirectly the diagonal paylines) identified for re-draw or replay. At 455, payouts related to the five-card hands formed along the five horizontal paylines and two diagonal paylines are determined and paid. Screen shot 355 of FIG. 6f shows the winning hands identified by the removal of non-winning cards and winning hand designations 535-1 (straight) and 535-2 (2 pairs). Winning hands may be identified in a myriad of ways including highlighting the winning cards, removing the losing cards, altering the color of the winning cards, extending a border around the winning cards, labeling the winning cards, etc.

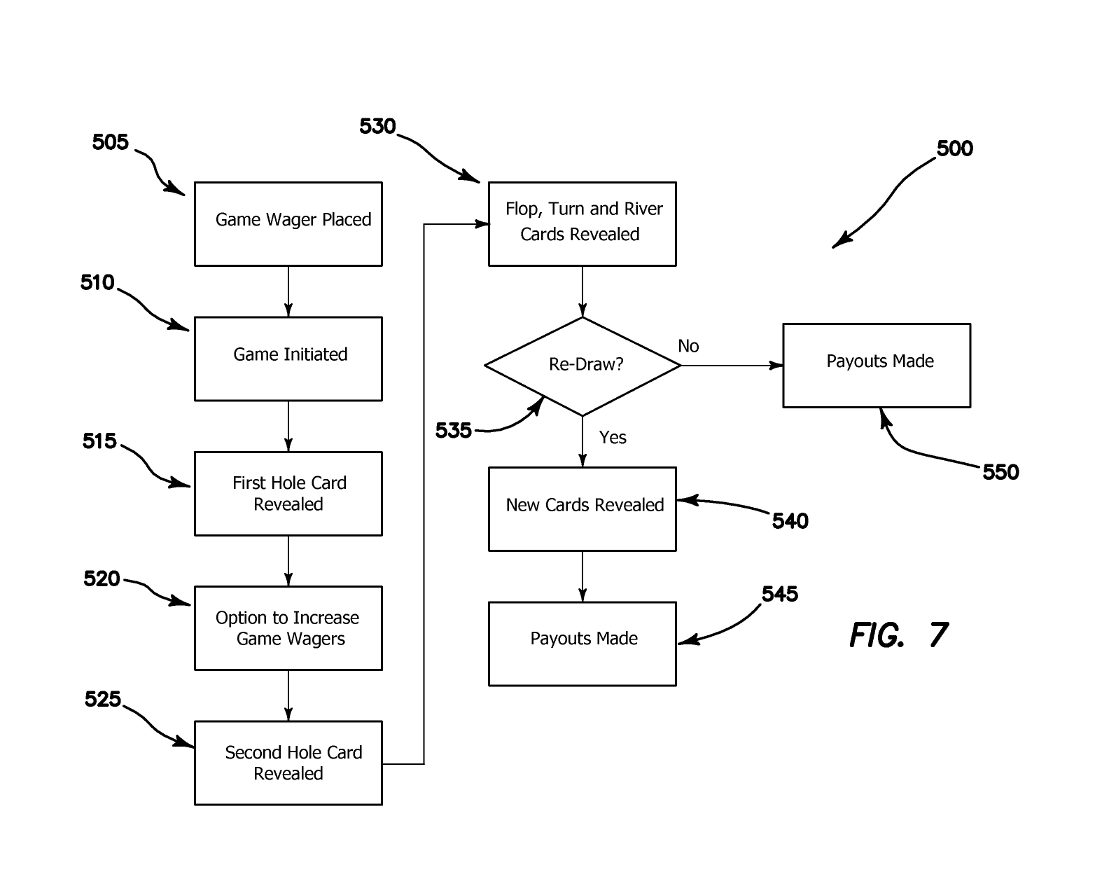

FIG. 7 shows a flow chart 500 detailing another methodology of conducting a video game according to the embodiments of the present invention. At 505, a game wager is placed. Once the wager is placed, at 510, the player initiates play by utilizing a deal button, icon or other interface member. At 515, a first hole card is revealed. At 520, the player has the option to increase the wager placed at 505. At 525, a second hole card is revealed. At 530, the flop, turn and river cards are all revealed. At 535, players have the option to re-draw the cards along one or more of the five horizontal paylines. If no re-draws are requested, at 540, payouts related to the five-card hands formed along the five horizontal paylines and/or two diagonal paylines are determined and paid. If re-draws are requested, at 545, new replacement cards are displayed along the horizontal paylines (and indirectly the diagonal paylines) identified for re-draw or replay. At 550, payouts related to the five-card hands formed along the five horizontal paylines and two diagonal paylines are determined and paid.

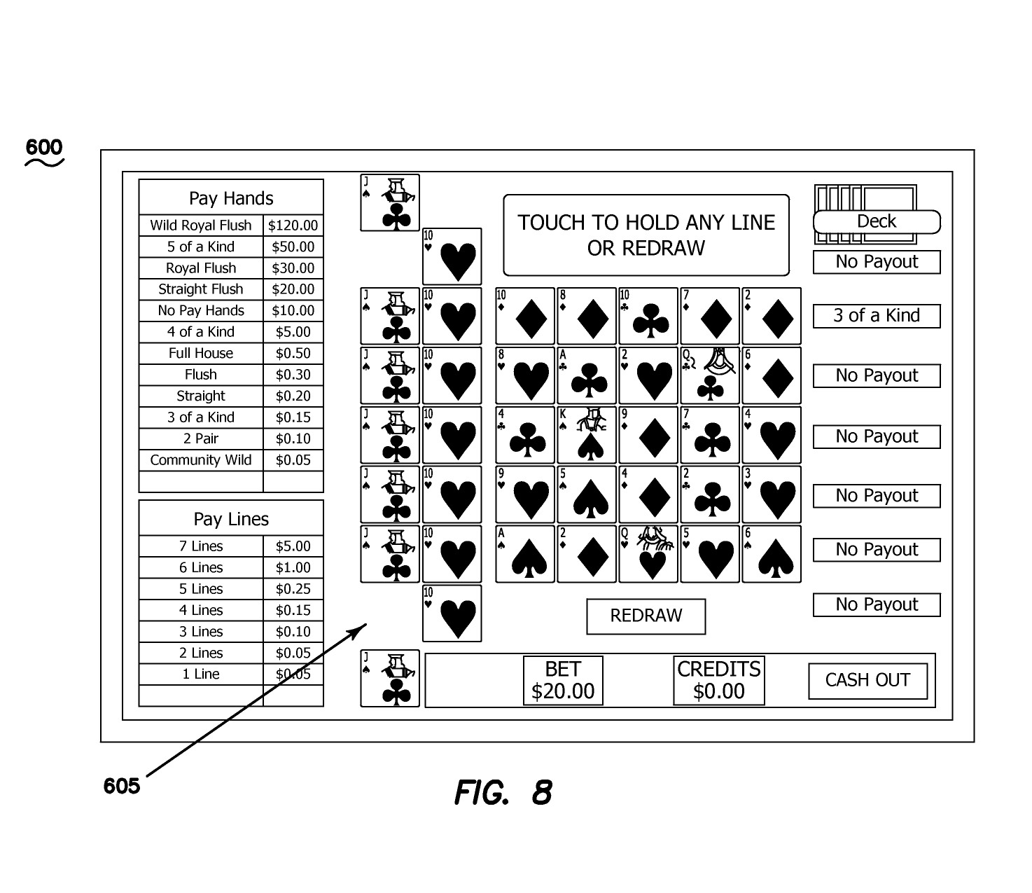

FIG. 8 shows a screen shot 600 depicting an exemplary graphic user interface 605 of a video poker game played according to the embodiments of the present invention. The graphic user interface 605 may take on countless themes, looks and feels as desired by the manufacturer, operator and/or venue offering the game.

In one embodiment, a free or for-charge “Rabbit Hunt” or “Do Over” feature allows a player to replay the hand such that the player may hold/redraw different lines. In one embodiment, if the “Rabbit Hunt” or “Do Over” feature is for charge, the game is replayed and the player may receive payouts based on the new results. With a free feature, the replay outcome is intended to be educational to the player.

In one embodiment, the player receives a payout for the rank of the five-card poker hand formed along each of the five horizontal paylines and two diagonal paylines. Table 3 shows a pay table listing the various payouts based on a fifty seven card deck (including Eagles) and one unit being bet. Table 4 shows a pay table including a special, optional payout related to the seven paylines forming no payable hands.

TABLE 3
(Horizontal and Diagonal Paylines)

| Rank of Hand | Payout (1 Unit Bet) |
|---|---|
| Any Eagle | .05 |
| Three of a Kind | 1 |
| Straight | 3 |
| Flush | 5 |
| Full House | 7 |
| Four of a Kind | 20 |
| Straight Flush | 30 |
| Royal Flush | 100 |
| Five of a Kind | 100 |
| Seven-Card Straight Flush | 50,000 |
| Seven-Card Royal Flush | 100,000 |
| (8-9-10-J-Q-K-A) | |

TABLE 4

| Rank of Hand | Payout (1 Unit Bet) |
|---|---|
| No Payable Hands Along | 18 |
| Seven Paylines | |

There are countless numbers of conceivable pay tables suitable for the embodiments of the present invention. Tables 5 through 46 illustrate various exemplary fixed payout pay tables. Those skilled in the art will recognize that progressive jackpots and other dynamic payouts may be incorporated into the pay tables. Moreover, other unique payouts are available based on the structure of the 5×5 matrix. For example, a bonus maybe paid or multiplier implemented responsive to both diagonal paylines defining winning hands.

Table 5 shows a pay table for horizontal and diagonal paylines and Table 6 shows a pay table including a special, optional payout related to the seven paylines forming no payable hands, for a 57-card/7-Bet/Two Pairs or Better (Horizontal)/Two Pairs or Better (Diagonal) embodiment.

TABLE 5
(Horizontal and Diagonal)

| Rank of Hand | Payout (1 Unit Bet) |
|---|---|
| High Card | 0 |
| Pairs | 0 |
| Two Pairs | 0.02 |
| Any Eagle | 0.02 |
| Three of a Kind | 1 |
| Straight | 3 |
| Flush | 5 |
| Full House | 7 |
| Four of a Kind | 20 |
| Straight Flush | 40 |
| Royal Flush | 150 |
| Five of a Kind | 150 |
| Seven-Card Straight Flush | 50,000 |
| Seven-Card Royal Flush | 100,000 |
| (8-9-10-J-Q-K-A) | |

TABLE 6

| Rank of Hand | Payout (1 Unit Bet) |
|---|---|
| No Payable Hands Along | 1000 |
| Seven Paylines | |

Tables 7 and 8 show pay tables for horizontal and diagonal paylines, respectively, for a 52-card/7-Bet/Trips or Better (Horizontal)/Full House or Better (Diagonal) embodiment.

TABLE 7
(Horizontal)

| Rank of Hand | Payout (1 Unit Bet) |
|---|---|
| Three of a Kind | 1 |
| Straight | 2 |
| Flush | 4 |
| Full House | 5 |
| Four of a Kind | 18 |
| Straight Flush | 30 |
| Royal Flush | 100 |
| Seven-Card Straight Flush | 25,000 |
| Seven-Card Royal Flush | 75,000 |
| (8-9-10-J-Q-K-A) | |

TABLE 8
(Diagonal)

| Rank of Hand | Payout (1 Unit Bet) |
|---|---|
| Three of a Kind | 0 |
| Straight | 0 |
| Flush | 0 |
| Full House | 9 |
| Four of a Kind | 20 |
| Straight Flush | 40 |
| Royal Flush | 150 |
| Seven-Card Straight Flush | 30,000 |
| Seven-Card Royal Flush | 100,000 |
| (8-9-10-J-Q-K-A) | |

Tables 9 and 10 show pay tables for horizontal and diagonal paylines, respectively, for a 57-card/7-Bet/Trips or Better (Horizontal)/Full House or Better (Diagonal) embodiment.

TABLE 9
(Horizontal)

| Rank of Hand | Payout (1 Unit Bet) |
|---|---|
| Three of a Kind | 1 |
| Straight | 3 |
| Flush | 4 |
| Full House | 6 |
| Four of a Kind | 20 |
| Straight Flush | 40 |
| Royal Flush | 100 |
| Five of a Kind | 100 |
| Seven-Card Straight Flush | 25,000 |
| Seven-Card Royal Flush | 50,000 |
| (8-9-10-J-Q-K-A) | |

TABLE 10
(Diagonal)

| Rank of Hand | Payout (1 Unit Bet) |
|---|---|
| Three of a Kind | 0 |
| Straight | 0 |
| Flush | 0 |
| Full House | 10 |
| Four of a Kind | 15 |
| Straight Flush | 30 |
| Royal Flush | 150 |
| Five of a Kind | 150 |
| Seven-Card Straight Flush | 25,000 |
| Seven-Card Royal Flush | 50,000 |
| (8-9-10-J-Q-K-A) | |

Tables 11 and 12 show pay tables for horizontal and diagonal paylines, respectively, for a 52-card/7-Bet/Trips or Better (Horizontal)/Flush or Better (Diagonal) embodiment.

TABLE 11
(Horizontal)

| Rank of Hand | Payout (1 Unit Bet) |
|---|---|
| Three of a Kind | 1 |
| Straight | 2 |
| Flush | 4 |
| Full House | 5 |
| Four of a Kind | 18 |
| Straight Flush | 30 |
| Royal Flush | 100 |
| Seven-Card Straight Flush | 25,000 |
| Seven-Card Royal Flush | 75,000 |
| (8-9-10-J-Q-K-A) | |

TABLE 12
(Diagonal)

| Rank of Hand | Payout (1 Unit Bet) |
|---|---|
| Three of a Kind | 0 |
| Straight | 0 |
| Flush | 7 |
| Full House | 8 |
| Four of a Kind | 20 |
| Straight Flush | 40 |
| Royal Flush | 150 |
| Seven-Card Straight Flush | 30,000 |
| Seven-Card Royal Flush | 100,000 |
| (8-9-10-J-Q-K-A) | |

Tables 13 and 14 show pay tables for horizontal and diagonal paylines, respectively, for a 57-card/7-Bet/Trips or Better (Horizontal)/Flush or Better (Diagonal) embodiment.

TABLE 13
(Horizontal)

| Rank of Hand | Payout (1 Unit Bet) |
|---|---|
| Three of a Kind | 1 |
| Straight | 3 |
| Flush | 4 |
| Full House | 6 |
| Four of a Kind | 20 |
| Straight Flush | 40 |
| Royal Flush | 100 |
| Five of a Kind | 100 |
| Seven-Card Straight Flush | 25,000 |
| Seven-Card Royal Flush | 50,000 |
| (8-9-10-J-Q-K-A) | |

TABLE 14
(Diagonal)

| Rank of Hand | Payout (1 Unit Bet) |
|---|---|
| Three of a Kind | 0 |
| Straight | 0 |
| Flush | 7 |
| Full House | 9 |
| Four of a Kind | 15 |
| Straight Flush | 30 |
| Royal Flush | 150 |
| Five of a Kind | 150 |
| Seven-Card Straight Flush | 25,000 |
| Seven-Card Royal Flush | 50,000 |
| (8-9-10-J-Q-K-A) | |

Tables 15 and 16 show pay tables for horizontal and diagonal paylines, respectively, for a 52-card/7-Bet/Trips or Better (Horizontal)/Trips or Better (Diagonal) embodiment.

TABLE 15
(Horizontal)

| Rank of Hand | Payout (1 Unit Bet) |
|---|---|
| Three of a Kind | 1 |
| Straight | 2 |
| Flush | 5 |
| Full House | 6 |
| Four of a Kind | 25 |
| Straight Flush | 50 |
| Royal Flush | 25 |
| Seven-Card Straight Flush | 100,000 |
| Seven-Card Royal Flush | 1,000,000 |
| (8-9-10-J-Q-K-A) | |

TABLE 16
(Diagonal)

| Rank of Hand | Payout (1 Unit Bet) |
|---|---|
| Three of a Kind | 1 |
| Straight | 2 |
| Flush | 5 |
| Full House | 6 |
| Four of a Kind | 25 |
| Straight Flush | 50 |
| Royal Flush | 250 |
| Seven-Card Straight Flush | 100,000 |
| Seven-Card Royal Flush | 1,000,000 |
| (8-9-10-J-Q-K-A) | |

Tables 17 and 18 show pay tables for horizontal and diagonal paylines, respectively, for a 57-card/7-Bet/Trips or Better (Horizontal)/Trips or Better (Diagonal) embodiment.

TABLE 17
(Horizontal)

| Rank of Hand | Payout (1 Unit Bet) |
|---|---|
| Three of a Kind | 1 |
| Straight | 3 |
| Flush | 5 |
| Full House | 7 |
| Four of a Kind | 30 |
| Straight Flush | 50 |
| Royal Flush | 250 |
| Five of a Kind | 250 |
| Seven-Card Straight Flush | 75,000 |
| Seven-Card Royal Flush | 1,000,000 |
| (8-9-10-J-Q-K-A) | |

TABLE 18
(Diagonal)

| Rank of Hand | Payout (1 Unit Bet) |
|---|---|
| Three of a Kind | 1 |
| Straight | 3 |
| Flush | 5 |
| Full House | 7 |
| Four of a Kind | 25 |
| Straight Flush | 40 |
| Royal Flush | 200 |
| Five of a Kind | 250 |
| Seven-Card Straight Flush | 100,000 |
| Seven-Card Royal Flush | 1,000,000 |
| (8-9-10-J-Q-K-A) | |

Tables 19 and 20 show pay tables for horizontal and diagonal paylines, respectively, for a 52-card/5-Bet/Trips or Better (Horizontal)/Seven Card Royal Flush (Diagonal) embodiment.

TABLE 19
(Horizontal)

| Rank of Hand | Payout (1 Unit Bet) |
|---|---|
| Three of a Kind | 1 |
| Straight | 2 |
| Flush | 5 |
| Full House | 6 |
| Four of a Kind | 25 |
| Straight Flush | 40 |
| Royal Flush | 250 |
| Seven-Card Straight Flush | 75,000 |
| Seven-Card Royal Flush | 150,000 |
| (8-9-10-J-Q-K-A) | |

TABLE 20
(Diagonal)

| Rank of Hand | Payout (1 Unit Bet) |
|---|---|
| Three of a Kind | 0 |
| Straight | 0 |
| Flush | 0 |
| Full House | 0 |
| Four of a Kind | 0 |
| Straight Flush | 0 |
| Royal Flush | 0 |
| Seven-Card Straight Flush | 0 |
| Seven-Card Royal Flush | 1,000,000 |
| (8-9-10-J-Q-K-A) | |

Tables 21 and 22 show pay tables for horizontal and diagonal paylines, respectively, for a 57-card/5-Bet/Trips or Better (Horizontal)/Seven Card Royal Flush (Diagonal) embodiment.

TABLE 21
(Horizontal)

| Rank of Hand | Payout (1 Unit Bet) |
|---|---|
| Three of a Kind | 1 |
| Straight | 3 |
| Flush | 5 |
| Full House | 7 |
| Four of a Kind | 25 |
| Straight Flush | 50 |
| Royal Flush | 200 |
| Five of a Kind | 200 |
| Seven-Card Straight Flush | 100,000 |
| Seven-Card Royal Flush | 300,000 |
| (8-9-10-J-Q-K-A) | |

TABLE 22
(Diagonal)

| Rank of Hand | Payout (1 Unit Bet) |
|---|---|
| Three of a Kind | 0 |
| Straight | 0 |
| Flush | 0 |
| Full House | 0 |
| Four of a Kind | 0 |
| Straight Flush | 0 |
| Royal Flush | 0 |
| Five of a Kind | 0 |
| Seven-Card Straight Flush | 0 |
| Seven-Card Royal Flush (8- | 1,000,000 |
| 9-10-J-Q-K-A) | |

Tables 23 and 24 show pay tables for horizontal and diagonal paylines, respectively, for a 52-card/5-Bet/Trips or Better (Horizontal)/Quads or Better (Diagonal) embodiment.

TABLE 23
(Horizontal)

| Rank of Hand | Payout (1 Unit Bet) |
|---|---|
| Three of a Kind | 1 |
| Straight | 2 |
| Flush | 5 |
| Full House | 6 |
| Four of a Kind | 18 |
| Straight Flush | 30 |
| Royal Flush | 100 |
| Seven-Card Straight Flush | 25,000 |
| Seven-Card Royal Flush | 75,000 |
| (8-9-10-J-Q-K-A) | |

TABLE 24
(Diagonal)

| Rank of Hand | Payout (1 Unit Bet) |
|---|---|
| Three of a Kind | 0 |
| Straight | 0 |
| Flush | 0 |
| Full House | 0 |
| Four of a Kind | 20 |
| Straight Flush | 40 |
| Royal Flush | 150 |
| Seven-Card Straight Flush | 30,000 |
| Seven-Card Royal Flush | 100,000 |
| (8-9-10-J-Q-K-A) | |

Tables 25 and 26 show pay tables for horizontal and diagonal paylines, respectively, for a 57-card/5-Bet/Trips or Better (Horizontal)/Quads or Better (Diagonal) embodiment.

TABLE 25
(Horizontal)

| Rank of Hand | Payout (1 Unit Bet) |
|---|---|
| Three of a Kind | 1 |
| Straight | 3 |
| Flush | 5 |
| Full House | 7 |
| Four of a Kind | 20 |
| Straight Flush | 40 |
| Royal Flush | 100 |
| Five of a Kind | 100 |
| Seven-Card Straight Flush | 25,000 |
| Seven-Card Royal Flush | 50,000 |
| (8-9-10-J-Q-K-A) | |

TABLE 26
(Diagonal)

| Rank of Hand | Payout (1 Unit Bet) |
|---|---|
| Three of a Kind | 0 |
| Straight | 0 |
| Flush | 0 |
| Full House | 0 |
| Four of a Kind | 15 |
| Straight Flush | 30 |
| Royal Flush | 150 |
| Five of a Kind | 150 |
| Seven-Card Straight Flush | 30,000 |
| Seven-Card Royal Flush | 100,000 |
| (8-9-10-J-Q-K-A) | |

Tables 27 and 28 show pay tables for horizontal and diagonal paylines, respectively, for a 52-card/1-7 Bet/Trips or Better (Horizontal)/Full House or Better (Diagonal) embodiment.

TABLE 27
(Horizontal)

| Rank of Hand | Payout (1 Unit Bet) |
|---|---|
| Three of a Kind | 1 |
| Straight | 2 |
| Flush | 4 |
| Full House | 5 |
| Four of a Kind | 18 |
| Straight Flush | 30 |
| Royal Flush | 100 |
| Seven-Card Straight Flush | 25,000 |
| Seven-Card Royal Flush | 75,000 |
| (8-9-10-J-Q-K-A) | |

TABLE 28
(Diagonal)

| Rank of Hand | Payout (1 Unit Bet) |
|---|---|
| Three of a Kind | 0 |
| Straight | 0 |
| Flush | 0 |
| Full House | 9 |
| Four of a Kind | 20 |
| Straight Flush | 40 |
| Royal Flush | 150 |
| Seven-Card Straight Flush | 30,000 |
| Seven-Card Royal Flush | 100,000 |
| (8-9-10-J-Q-K-A) | |

Tables 29 and 30 show pay tables for horizontal and diagonal paylines, respectively, for a 57-card/1-7 Bet/Trips or Better (Horizontal)/Full House or Better (Diagonal) embodiment.

TABLE 29
(Horizontal)

| Rank of Hand | Payout (1 Unit Bet) |
|---|---|
| Three of a Kind | 1 |
| Straight | 3 |
| Flush | 4 |
| Full House | 6 |
| Four of a Kind | 20 |
| Straight Flush | 40 |
| Royal Flush | 100 |
| Five of a Kind | 100 |
| Seven-Card Straight Flush | 25,000 |
| Seven-Card Royal Flush | 50,000 |
| (8-9-10-J-Q-K-A) | |

TABLE 30
(Diagonal)

| Rank of Hand | Payout (1 Unit Bet) |
|---|---|
| Three of a Kind | 0 |
| Straight | 0 |
| Flush | 0 |
| Full House | 10 |
| Four of a Kind | 15 |
| Straight Flush | 30 |
| Royal Flush | 150 |
| Five of a Kind | 150 |
| Seven-Card Straight Flush | 25,000 |
| Seven-Card Royal Flush | 50,000 |
| (8-9-10-J-Q-K-A) | |

Tables 31 and 32 show pay tables for horizontal and diagonal paylines, respectively, for a 52-card/1-7 Bet/Trips or Better (Horizontal)/Flush or Better (Diagonal) embodiment.

TABLE 31
(Horizontal)

| Rank of Hand | Payout (1 Unit Bet) |
|---|---|
| Three of a Kind | 1 |
| Straight | 2 |
| Flush | 4 |
| Full House | 5 |
| Four of a Kind | 18 |
| Straight Flush | 30 |
| Royal Flush | 100 |
| Seven-Card Straight Flush | 25,000 |
| Seven-Card Royal Flush | 75,000 |
| (8-9-10-J-Q-K-A) | |

TABLE 32
(Diagonal)

| Rank of Hand | Payout (1 Unit Bet) |
|---|---|
| Three of a Kind | 0 |
| Straight | 0 |
| Flush | 7 |
| Full House | 8 |
| Four of a Kind | 20 |
| Straight Flush | 40 |
| Royal Flush | 150 |
| Seven-Card Straight Flush | 30,000 |
| Seven-Card Royal Flush | 100,000 |
| (8-9-10-J-Q-K-A) | |

Tables 33 and 34 show pay tables for horizontal and diagonal paylines, respectively, for a 57-card/1-7 Bet/Trips or Better (Horizontal)/Flush or Better (Diagonal) embodiment.

TABLE 33
(Horizontal)

| Rank of Hand | Payout (1 Unit Bet) |
|---|---|
| Three of a Kind | 1 |
| Straight | 3 |
| Flush | 4 |
| Full House | 6 |
| Four of a Kind | 20 |
| Straight Flush | 40 |
| Royal Flush | 100 |
| Five of a Kind | 100 |
| Seven-Card Straight Flush | 25,000 |
| Seven-Card Royal Flush | 50,000 |
| (8-9-10-J-Q-K-A) | |

TABLE 34
(Diagonal)

| Rank of Hand | Payout (1 Unit Bet) |
|---|---|
| Three of a Kind | 0 |
| Straight | 0 |
| Flush | 7 |
| Full House | 9 |
| Four of a Kind | 15 |
| Straight Flush | 30 |
| Royal Flush | 150 |
| Five of a Kind | 150 |
| Seven-Card Straight Flush | 25,000 |
| Seven-Card Royal Flush | 50,000 |
| (8-9-10-J-Q-K-A) | |

Tables 35 and 36 show pay tables for horizontal and diagonal paylines, respectively, for a 52-card/1-7 Bet/Trips or Better (Horizontal)/Trips or Better (Diagonal) embodiment.

TABLE 35
(Horizontal)

| Rank of Hand | Payout (1 Unit Bet) |
|---|---|
| Three of a Kind | 1 |
| Straight | 2 |
| Flush | 5 |
| Full House | 6 |
| Four of a Kind | 25 |
| Straight Flush | 50 |
| Royal Flush | 250 |
| Seven-Card Straight Flush | 100,000 |
| Seven-Card Royal Flush | 1,000,000 |
| (8-9-10-J-Q-K-A) | |

TABLE 36
(Diagonal)

| Rank of Hand | Payout (1 Unit Bet) |
|---|---|
| Three of a Kind | 1 |
| Straight | 2 |
| Flush | 5 |
| Full House | 6 |
| Four of a Kind | 25 |
| Straight Flush | 50 |
| Royal Flush | 250 |
| Seven-Card Straight Flush | 100,000 |
| Seven-Card Royal Flush | 1,000,000 |
| (8-9-10-J-Q-K-A) | |

Tables 37 and 38 show pay tables for horizontal and diagonal paylines, respectively, for a 57card/1-7 Bet/Trips or Better (Horizontal)/Trips or Better (Diagonal) embodiment.

TABLE 37
(Horizontal)

| Rank of Hand | Payout (1 Unit Bet) |
|---|---|
| Three of a Kind | 1 |
| Straight | 3 |
| Flush | 5 |
| Full House | 7 |
| Four of a Kind | 30 |
| Straight Flush | 50 |
| Royal Flush | 250 |
| Five of a Kind | 250 |
| Seven-Card Straight Flush | 75,000 |
| Seven-Card Royal Flush | 1,000,000 |
| (8-9-10-J-Q-K-A) | |

TABLE 38
(Diagonal)

| Rank of Hand | Payout (1 Unit Bet) |
|---|---|
| Three of a Kind | 1 |
| Straight | 3 |
| Flush | 5 |
| Full House | 7 |
| Four of a Kind | 30 |
| Straight Flush | 50 |
| Royal Flush | 250 |
| Five of a Kind | 250 |
| Seven-Card Straight Flush | 75,000 |
| Seven-Card Royal Flush | 1,000,000 |
| (8-9-10-J-Q-K-A) | |

Tables 39 and 40 show pay tables for horizontal and diagonal paylines, respectively, for a 52-card/1-5 Bet/Trips or Better (Horizontal)/Seven-Card Royal Flush (Diagonal) embodiment.

TABLE 39
(Horizontal)

| Rank of Hand | Payout (1 Unit Bet) |
|---|---|
| Three of a Kind | 1 |
| Straight | 2 |
| Flush | 5 |
| Full House | 6 |
| Four of a Kind | 25 |
| Straight Flush | 40 |
| Royal Flush | 200 |
| Seven-Card Straight Flush | 75,000 |
| Seven-Card Royal Flush | 150,000 |
| (8-9-10-J-Q-K-A) | |

TABLE 40
(Diagonal)

| Rank of Hand | Payout (1 Unit Bet) |
|---|---|
| Three of a Kind | 0 |
| Straight | 0 |
| Flush | 0 |
| Full House | 0 |
| Four of a Kind | 0 |
| Straight Flush | 0 |
| Royal Flush | 0 |
| Seven-Card Straight Flush | 0 |
| Seven-Card Royal Flush | 1,000,000 |
| (8-9-10-J-Q-K-A) | |

Tables 41 and 42 show pay tables for horizontal and diagonal paylines, respectively, for a 57-card/1-7 Bet/Trips or Better (Horizontal)/Trips or Better (Diagonal) embodiment.

TABLE 41
(Horizontal)

| Rank of Hand | Payout (1 Unit Bet) |
|---|---|
| Three of a Kind | 1 |
| Straight | 3 |
| Flush | 5 |
| Full House | 7 |
| Four of a Kind | 25 |
| Straight Flush | 50 |
| Royal Flush | 200 |
| Five of a Kind | 200 |
| Seven-Card Straight Flush | 100,000 |
| Seven-Card Royal Flush | 300,000 |
| (8-9-10-J-Q-K-A) | |

TABLE 42
(Diagonal)

| Rank of Hand | Payout (1 Unit Bet) |
|---|---|
| Three of a Kind | 0 |
| Straight | 0 |
| Flush | 0 |
| Full House | 0 |
| Four of a Kind | 0 |
| Straight Flush | 0 |
| Royal Flush | 0 |
| Five of a Kind | 0 |
| Seven-Card Straight Flush | 0 |
| Seven-Card Royal Flush | 1,000,000 |
| (8-9-10-J-Q-K-A) | |

Tables 43 and 44 show pay tables for horizontal and diagonal paylines, respectively, for a 52-card/1-5 Bet/Trips or Better (Horizontal)/Quads or Better (Diagonal) embodiment.

TABLE 43
(Horizontal)

| Rank of Hand | Payout (1 Unit Bet) |
|---|---|
| Three of a Kind | 1 |
| Straight | 2 |
| Flush | 5 |
| Full House | 6 |
| Four of a Kind | 18 |
| Straight Flush | 30 |
| Royal Flush | 100 |
| Seven-Card Straight Flush | 25,000 |
| Seven-Card Royal Flush | 75,000 |
| (8-9-10-J-Q-K-A) | |

TABLE 44
(Diagonal)

| Rank of Hand | Payout (1 Unit Bet) |
|---|---|
| Three of a Kind | 0 |
| Straight | 0 |
| Flush | 0 |
| Full House | 0 |
| Four of a Kind | 20 |
| Straight Flush | 40 |
| Royal Flush | 150 |
| Seven-Card Straight Flush | 30,000 |
| Seven-Card Royal Flush | 100,000 |
| (8-9-10-J-Q-K-A) | |

Tables 45 and 46 show pay tables for horizontal and diagonal paylines, respectively, for a 57-card/1-5 Bet/Trips or Better (Horizontal)/Quads or Better (Diagonal) embodiment.

TABLE 45
(Horizontal)

| Rank of Hand | Payout (1 Unit Bet) |
|---|---|
| Three of a Kind | 1 |
| Straight | 3 |
| Flush | 5 |
| Full House | 7 |
| Four of a Kind | 20 |
| Straight Flush | 40 |
| Royal Flush | 100 |
| Five of a Kind | 100 |
| Seven-Card Straight Flush | 25,000 |
| Seven-Card Royal Flush | 50,000 |
| (8-9-10-J-Q-K-A) | |

TABLE 46
(Diagonal)

| Rank of Hand | Payout (1 Unit Bet) |
|---|---|
| Three of a Kind | 0 |
| Straight | 0 |
| Flush | 0 |
| Full House | 0 |
| Four of a Kind | 15 |
| Straight Flush | 30 |
| Royal Flush | 150 |
| Five of a Kind | 250 |
| Seven-Card Straight Flush | 30,000 |
| Seven-Card Royal Flush | 100,000 |
| (8-9-10-J-Q-K-A) | |

Although the invention has been described in detail with reference to several embodiments, additional variations and modifications exist within the scope and spirit of the invention as described and defined in the following claims.

1. An electronically implemented method of conducting a video poker game comprising:
utilizing at least memory, random number generator and processor to facilitate:
randomizing via said random number generator a group of simulated playing cards;
accepting an initial game wager placed via a user interface in communication with said processor;
causing two random hole cards from said group of simulated playing cards to be revealed on a display;
causing five, five-card poker hands from said group of simulated playing cards to be revealed on said display, said five, five-card poker hands displayed in the form of a 5×5 matrix;
responsive to received replacement poker hand input by a player via said user interface, replacing one or more of said five, five-card poker hands with new five-card poker hands from said group of simulated cards, no individual cards being replaceable;
causing said new five, five-card poker hands from said group of simulated playing cards to be revealed on said display in place of one or more replaced five-card poker hands;
via said processor, determining ranks of each of said five, five-card poker hands in combination with said pair of hole cards; and
via said processor, making payouts based on ranks of one or more of said five, five-card poker hands in combination with said two hole cards.

2. The electronically implemented method of claim 1 further comprising:
via said processor, determining ranks of two diagonally oriented five-card poker hands in combination with said pair of hole cards; and
via said processor, making payouts based on ranks of said two diagonally oriented five-card poker hands in combination with said pair of hole cards.

3. The electronically implemented method of claim 1 further comprising:
causing said five, five-card poker hands from said group of simulated playing cards to be revealed on said display as follows: three flop cards first in time; turn card next in time and river card last in time.

4. The electronically implemented method of claim 1 further comprising:
causing replicas of said two random hole cards from said group of simulated playing cards to be revealed on a display such that replicas of said two hole cards are proximate to each of said five, five-card poker hands.

5. The electronically implemented method of claim 2 further comprising:
causing replicas of said two random hole cards from said group of simulated playing cards to be revealed on a display such that replicas of said two hole cards are proximate to each of said two diagonally oriented five-card poker hands.

6. The electronically implemented method of claim 1 further comprising:
accepting an initial game wager placed via a user interface in communication with said processor wherein said initial game wager comprises individual wagers for each of said five, five-card poker hands to be played.

7. The electronically implemented method of claim 2 further comprising:
accepting an initial game wager placed via a user interface in communication with said processor wherein said initial game wagers comprise individual wagers for each of seven, five-card poker hands to be played, said seven, five-card poker hands comprising five horizontal and two diagonal poker hands.

8. An electronically implemented method of conducting a video poker game comprising:
utilizing at least memory, random number generator and processor to facilitate:
randomizing via said random number generator a group of simulated playing cards;
accepting an initial game wager placed via a user interface in communication with said processor;
causing a first random hole card from said group of simulated playing cards to be revealed on a display;
responsive to input by a player, increasing said initial game wager placed via said user interface in communication with said processor;
causing a second random hole card from said group of simulated playing cards to be revealed on a display;
causing five, five-card poker hands from said group of simulated playing cards to be revealed on said display, said five, five-card poker hands displayed in the form of a 5×5 matrix;
responsive to received replacement poker hand input by a player via said user interface, replacing one or more of said five, five-card poker hands with new five-card poker hands from said group of simulated cards, no individual cards being replaceable;
causing said new five, five-card poker hands from said group of simulated playing cards to be revealed on said display in place of one or more replaced five-card poker hands;
via said processor, determining ranks of each of said five, five-card poker hands in combination with said pair of hole cards; and
via said processor, making payouts based on ranks of one or more of said five, five-card poker hands in combination with said first and second hole cards.

9. The electronically implemented method of claim 8 further comprising:
via said processor, determining ranks of two diagonally oriented five-card poker hands in combination with said two hole cards; and
via said processor, making payouts based on ranks of said two diagonally oriented five-card poker hands in combination with said two hole cards.

10. The electronically implemented method of claim 8 further comprising:
causing said five, five-card poker hands from said group of simulated playing cards to be revealed on said display as follows: three flop cards first in time; turn card next in time and river card last in time.

11. The electronically implemented method of claim 8 further comprising:
causing replicas of said two random hole cards from said group of simulated playing cards to be revealed on a display such that replicas of said two hole cards are proximate to each of said five, five-card poker hands.

12. The electronically implemented method of claim 8 further comprising:
causing replicas of said two random hole cards from said group of simulated playing cards to be revealed on a display such that replicas of said two hole cards are proximate to each of said two diagonally oriented five-card poker hands.

13. The electronically implemented method of claim 8 further comprising:
accepting an initial game wager placed via a user interface in communication with said processor wherein said initial game wager comprises individual wagers for each of said five, five-card poker hands to be played.

14. The electronically implemented method of claim 9 further comprising:
accepting an initial game wager placed via a user interface in communication with said processor wherein said initial game wagers comprise individual wagers for each of seven, five-card poker hands to be played, said seven, five-card poker hands comprising five horizontal and two diagonal poker hands.

15. An electronically implemented method of conducting a video poker game comprising:
utilizing at least memory, random number generator and processor to facilitate:
randomizing via said random number generator a group of simulated playing cards, said group of simulated playing cards comprising fifty-seven cards including thirteen cards depicting a suit of Hearts and ranks 2 through 10, Jack, Queen, King and Ace, thirteen cards depicting a suit of Diamonds and ranks 2 through 10, Jack, Queen, King and Ace, thirteen cards depicting a suit of Spades and ranks 2 through 10, Jack, Queen, King and Ace, thirteen cards depicting a suit of Clubs and ranks 2 through 10, Jack, Queen, King and Ace, and five cards depicting a fifth different suit and ranks 10, Jack, Queen, King and Ace;
accepting an initial game wager placed via a user interface in communication with said processor;
causing two random hole cards from said group of simulated playing cards to be revealed on a display;
causing five, five-card poker hands from said group of simulated playing cards to be revealed on said display, said five, five-card poker hands displayed in the form of a 5×5 matrix;
responsive to received replacement poker hand input by a player via said user interface, replacing one or more of said five, five-card poker hands with new five-card poker hands from said group of simulated cards, no individual cards being replaceable;
causing said new five, five-card poker hands from said group of simulated playing cards to be revealed on said display in place of one or more replaced five-card poker hands;
via said processor, determining ranks of each of said five, five-card poker hands in combination with said pair of hole cards; and
via said processor, making payouts based on ranks of one or more of said five, five-card poker hands in combination with said two hole cards.

16. The electronically implemented method of claim 15 further comprising:
via said processor, determining ranks of two diagonally oriented five-card poker hands in combination with said pair of hole cards; and
via said processor, making payouts based on ranks of said two diagonally oriented five-card poker hands in combination with said pair of hole cards.

17. The electronically implemented method of claim 15 further comprising:
causing replicas of said two random hole cards from said group of simulated playing cards to be revealed on a display such that replicas of said two hole cards are proximate to each of said five, five-card poker hands.

18. The electronically implemented method of claim 15 further comprising:
causing replicas of said two random hole cards from said group of simulated playing cards to be revealed on a display such that replicas of said two hole cards are proximate to each of said two diagonally oriented five-card poker hands.

19. The electronically implemented method of claim 15 further comprising:
accepting an initial game wager placed via a user interface in communication with said processor wherein said initial game wager comprises individual wagers for each of said five, five-card poker hands to be played.

20. The electronically implemented method of claim 16 further comprising:
accepting an initial game wager placed via a user interface in communication with said processor wherein said initial game wagers comprise individual wagers for each of seven, five-card poker hands to be played, said seven, five-card poker hands comprising five horizontal and two diagonal poker hands.
